(19) United States
(12) Patent Application Publication
(10) Pub. No.: US 2025/0082118 A1
(43) Pub. Date: Mar. 13, 2025

(54) BED HEATING SYSTEMS INCLUDING DC-HEATED BEDDING ASSEMBLIES AND/OR DC-POWERED CONTROL SYSTEMS

(71) Applicant: Ignik Outdoors, Inc., Bainbridge Island, WA (US)

(72) Inventors: Graeme ESAREY, Bainbridge Island, WA (US); Peter M. PONTANO, Seattle, WA (US); Graeme WAGONER, Seattle, WA (US); Mark A. CASTRACANE, Hattiesburg, MS (US)

(21) Appl. No.: 18/956,298

(22) Filed: Nov. 22, 2024

Related U.S. Application Data
(63) Continuation-in-part of application No. PCT/US2023/024155, filed on Jun. 1, 2023.
(60) Provisional application No. 63/602,015, filed on Nov. 22, 2023.
(60) Provisional application No. 63/347,829, filed on Jun. 1, 2022.

(51) Int. Cl. A47G 9/02; H05B 1/02; H05B 3/34

(52) U.S. Cl. CPC A47G 9/0215; H05B 1/0272; H05B 3/342; H05B 2203/003; H05B 2203/007; H05B 2203/037

(57) ABSTRACT

Bed heating systems that include a DC-heated bedding assembly and/or a DC-powered control system. The DC-heated bedding assembly includes a substrate, which supports a heating element configured to receive electrical power from a DC power supply and to generate a heat output to heat the substrate. The heating element may extend sinusoidally along the substrate. The heating element may be configured to generate different heat outputs in two or more zones of the substrate. The DC-powered control systems are configured to selectively regulate electrical power that is supplied to the heating element of the DC-heated bedding assembly. The DC-powered control systems are configured to monitor detected voltage(s) at one or more voltage taps positioned along the length of the heating element. Responsive to detecting a deviation between the detected voltage and an expected voltage, the DC-powered control systems may reduce and/or cease the supply of power to the heating element.

### RELATED APPLICATIONS

The following applications, from which priority is claimed, are incorporated herein in their entireties for all purposes: PCT Patent Application Serial No. PCT/US2023/024155, filed Jun. 1, 2023; and U.S. Provisional Patent Application Ser. No. 63/602,015, filed Nov. 22, 2023.

### FIELD OF THE DISCLOSURE

This disclosure relates to bed heating systems including DC-heated bedding assemblies and/or DC-powered control systems.

### BACKGROUND OF THE DISCLOSURE

Heated bedding, including heated pads, heated blankets, heated throws, etc., are widely used by outdoor recreationalists and for many other purposes. Conventional heated bedding typically includes a flexible fabric material that is heated by an electrically powered heating element and a controller that controls actuation of the heating element. While helpful to providing heating in cold environments, conventional heated bedding may include limitations relating to the heat distribution provided by the heating element and/or the ability to monitor and/or regulate the heat output of the heating element. Thus, there is a need for improved heated bed systems, such as which provide improved heated bedding assemblies and/or improved control systems for heated bedding assemblies.

### SUMMARY OF THE DISCLOSURE

Bed heating systems that include DC-heated bedding assemblies and/or DC-powered control systems are disclosed herein. The DC-heated bedding assemblies comprise a substrate and a heating element that is supported by the substrate. The heating element is configured to be operatively coupled to a DC power supply and to generate a heat output to heat the substrate. The DC-heated bedding assemblies further comprise at least one voltage tap positioned along a length of the heating element. A controller is connected in series between the DC power supply and the heating element. The controller is configured to selectively regulate the electrical power supplied to the heating element to control the heat output that is generated by the heating element. The controller is operatively coupled to the at least one voltage tap and is configured to monitor a detected voltage at the at least one voltage tap. The controller is configured to selectively regulate the electrical power that is supplied to the heating element based on the detected voltage at the at least one voltage tap.

The DC-powered control systems comprise a controller, which is configured to be connected in series between a DC power supply and a heating element, e.g., the heating element of the DC-heated bedding assemblies disclosed herein. The controller is configured to selectively regulate an electrical power that is supplied to the heating element to control the heat output generated by the heating element. In some examples, the controller is configured to monitor a detected voltage of at least one voltage tap positioned along a length of the heating element. The controller is configured to detect a deviation between the detected voltage at the at least one voltage tap and an expected voltage at the at least one voltage tap. Based on the detected deviation, the controller is configured to regulate the electrical power that is supplied to the heating element.

### BRIEF DESCRIPTION OF THE DRAWINGS

FIG. 1 is a schematic top plan view of examples of bed heating systems that include a DC-heated bedding assembly and a DC-powered control system according to aspects of the present disclosure.

FIG. 2 is a schematic sectional view of examples of DC-heated bedding assemblies according to aspects of the present disclosure.

FIG. 3 is a schematic top plan view of another example of a DC-heated bedding assembly according to aspects of the present disclosure.

FIG. 4 is a flow chart illustrating examples of control methods and processes that may be implemented by DC-powered control systems according to aspects of the present disclosure.

FIG. 5 is a schematic top plan view of examples of bed heating systems that include a plurality of DC-heated bedding assemblies according to aspects of the present disclosure.

### DETAILED DESCRIPTION AND BEST MODE OF THE DISCLOSURE

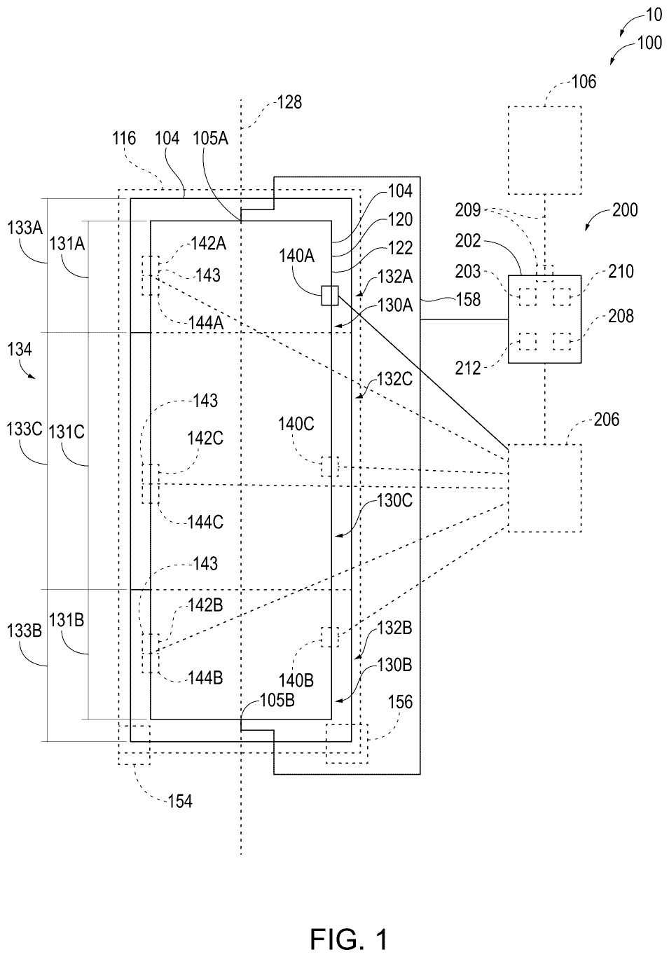

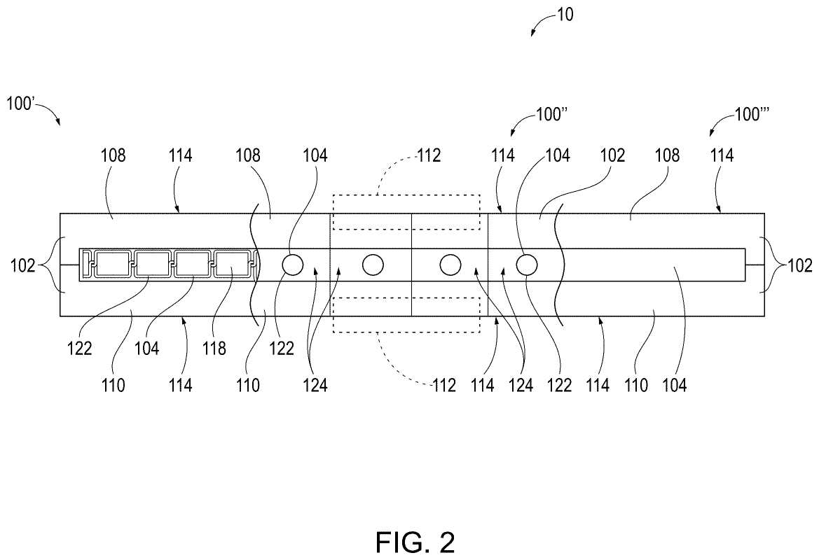

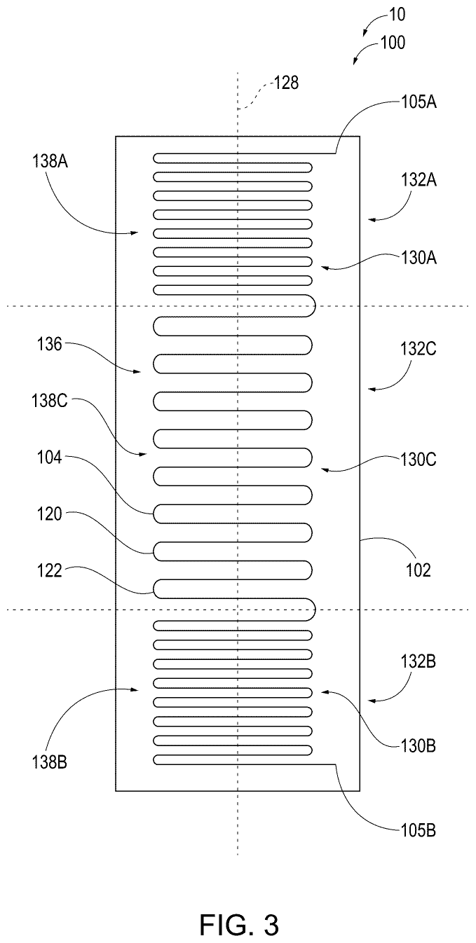

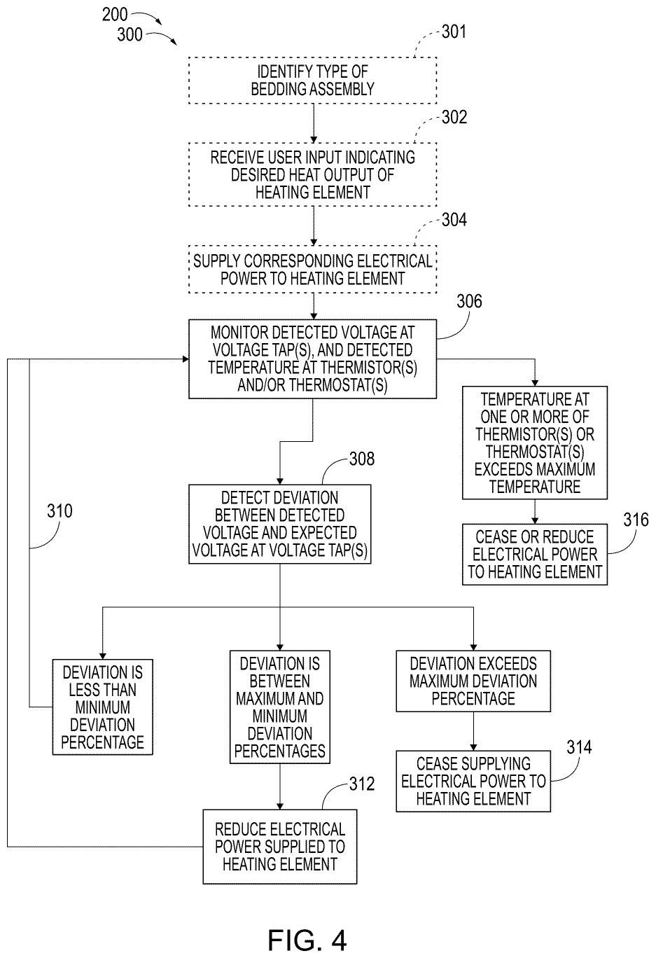

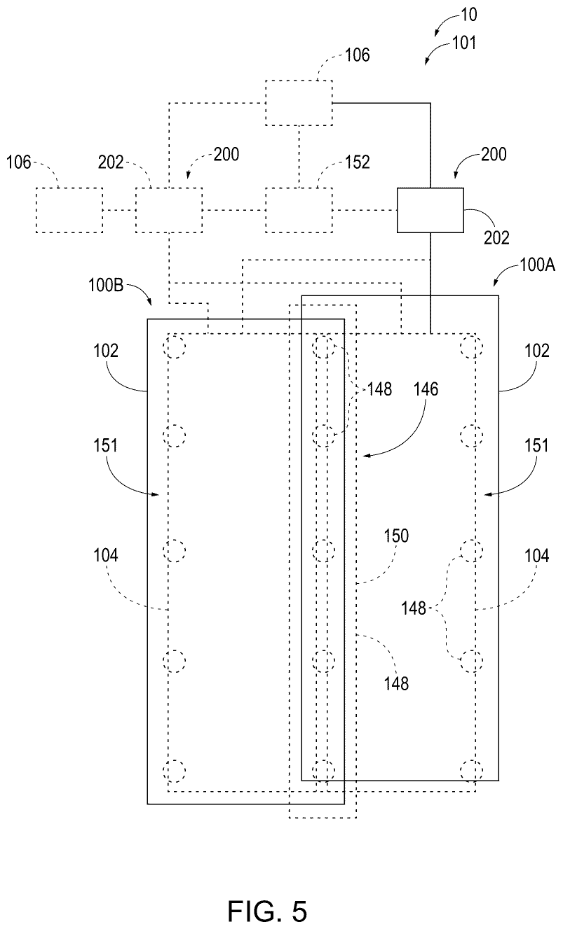

FIGS. 1-5 provide examples of bed heating systems 10 including DC-heated bedding assemblies 100 and/or DC-powered control systems 200 according to the present disclosure. FIG. 1 schematically illustrates bed heating systems 10 including DC-heated bedding assemblies 100 and DC-powered control systems 200. FIGS. 2 and 3 schematically illustrate examples of DC-heated bedding assemblies 100. FIG. 4 is a flow chart illustrating examples of control methods 300 that DC-powered control systems 200 may be configured to execute. FIG. 5 schematically illustrates a top plan view of examples of bed heating systems 10 that include a plurality of DC-heated bedding assemblies 100.

Elements that serve a similar, or at least substantially similar, purpose are labeled with like numbers in each of FIGS. 1-5, and these elements may not be discussed in detail herein with reference to each of FIGS. 1-5. Similarly, all elements may not be labeled in each of FIGS. 1-5, but reference numerals associated therewith may be utilized herein for consistency. Elements, components, and/or features that are discussed herein with reference to one or more of FIGS. 1-5 may be included in and/or utilized with any of FIGS. 1-5 without departing from the scope of the present disclosure.

FIG. 1 schematically illustrates a top plan view of bed heating systems 10 comprising DC-heated bedding assemblies 100 and DC-powered control systems 200. FIG. 2 schematically illustrates a sectional view of examples of DC-heated bedding assemblies 100 taken along a longitudinal axis 128 of a substrate 102 of DC-heated bedding assemblies 100. Although illustrated in FIG. 1 as including both a DC-heated bedding assembly 100 and a DC-powered control system 200, bed heating systems 10 according to the present disclosure may include a DC-heated bedding assembly 100 with a different control system (i.e., a control system other than a control system 200 according to the present disclosure) or a DC-powered control system 200 with a different DC-heating bedding assembly (i.e., a DC-heated bedding assembly other than a DC-heated bedding assembly 100 according to the present disclosure).

As shown in FIG. 1, DC-heated bedding assemblies 100 comprise a substrate 102 and a heating element 104 that is supported by substrate 102. Heating element 104 is configured to be operatively coupled to a DC power supply 106 in order to receive direct current (DC) electrical power from the DC power supply 106 and to generate a heat output to heat substrate 102. In some examples, DC-heated bedding assemblies 100 are configured to be utilized to heat any suitable heating surface 116 (e.g., a sleeping or sitting surface), such as a sleeping pad, a mattress, an air mattress, a cot, a sleeping bag, a tent floor, a ground surface, a textile material, a fabric material, a foam material, and/or a car seat that is put in contact with substrate 102. Heating surface 116 additionally or alternatively may be referred to as a support surface 116, a bedding surface 116, a sleeping surface 116, and/or a base surface 116. DC-heated bedding assembly 100 may be, may be described as, and/or may include a DC-heated sleeping pad, a DC-heated blanked, a DC-heated sleeping bag, a DC-heated mattress cover, a DC-heated throw, a DC-heated seat cover, and/or the like.

In some examples, bed heating systems 10 include DC-powered control systems 200 comprising a controller 202 that is configured to selectively control and/or regulate electrical power supplied to heating element 104 of DC-heated bedding assembly 100 by DC power supply 106. For example, controller 202 may be electrically connected, such as electronically connected in series, between DC power supply 106 and heating element 104 and configured to selectively regulate the electrical power supplied to heating element 104 and thus the heat output of the heating element. As described in more detail herein, DC-powered control systems 200 are configured to monitor a voltage of, such as a voltage along a length of, heating element 104, such as via one or more voltage taps along and/or associated with the heating element. DC-powered control systems 200 further may be configured to calculate and/or otherwise detect a deviation between the monitored voltage and an expected voltage and, responsive to such calculating and/or detecting, to regulate the electrical power supplied to the heating element based on the deviation.

Substrate 102 may comprise any suitable structure(s) that is/are configured to support heating element 104 and that is/are configured to be heated by heating element 104. In some examples, substrate 102 is configured to be selectively and repeatedly rolled, folded, and straightened into a plurality of different configurations including a plurality of different partially rolled, folded, and straightened positions. For example, one or more sections of substrate 102 may be rolled and/or folded at the same time that one or more other sections of substrate 102 may be straightened or flat. As another example, substrate 102 may be selectively rolled and/or folded into a storage or transport configuration and to selectively be unrolled and/or unfolded into a use configuration, which also may be referred to as an unrolled configuration, an unfolded configuration, an expanded configuration, a straightened configuration, and/or a sheet-like configuration. Substrate 102 may comprise a fabric material that is configured to be selectively and repeatedly rolled, folded, and straightened. In some examples, substrate 102 may comprise a microsuede material on at least one, if not both, exterior, or outer, surfaces of the substrate.

Substrate 102 is configured to support heating element 104, and as discussed, heating element 104 is configured to generate a heat output to heat substrate 102 responsive to electrical power delivered to the heating element, such as by control system 200. Heating element 104 may extend along, or within, at least a majority, if not a substantial portion of substrate 102. For example, heating element 104 may be sewn, threaded, woven, disposed, adhered, deposited, and/or formed in and/or on substrate 102.

As shown in FIG. 2 and described further below, in some examples, substrate 102 comprises a first outer layer 108 and a second outer layer 110 disposed on opposing sides of heating element 104. In such examples, heating element 104 is disposed between first outer layer 108 and second outer layer 110. In some examples, heating element 104 is embedded or otherwise extends and/or is positioned within substrate 102. For example, first outer layer 108 and second outer layer 110 may be coupled to each other around heating element 104, such that heating element 104 is embedded within substrate 102 between first outer layer 108 and second outer layer 110. First outer layer 108 and second outer layer 110 may be coupled to each other in any suitable manner, e.g., using stitching, sewing, adhesive, etc. In some examples, substrate 102 may comprise one or more inner layer(s) 118, which are configured to be disposed between and/or embedded within first outer layer 108 and second outer layer 110. In such examples, inner layers 118 may be operatively coupled to heating element 104. For example, as described further below, heating element 104 may be sewn, threaded, woven, disposed, adhered, deposited, and/or formed in and/or on the substrate sewn into one or more of inner layers 118 and sandwiched between first and second outer layers 108, 110.

Substrate 102 (e.g., first outer layer 108, second outer layer 110, and/or one or more inner layers 118) may comprise any suitable material and/or combination of materials that is/are configured to support heating element 104 and to be heated by heating element 104, and that is/are configured to be selectively and repeatedly folded, bent, and/or straightened. In some examples, one or both of first outer layer 108 and second outer layer 110 of substrate 102 comprise an anti-slip and/or high-friction material that is configured to restrict substrate 102 from slipping or otherwise moving relative to heating surface 116 (e.g., a sleeping surface) while heating surface 116 is being heated by DC-heated bedding assembly 100. For example, as shown in FIG. 2, first outer layer 108 and/or second outer layer 110 may have one or more anti-slip sections 112 that are disposed on external surface(s) 114 of first outer layer 108 and/or second outer layer 110 that are configured to restrict substrate 102 from slipping relative to heating surface 116. Alternatively, an entirety of external surface(s) 114 of first outer layer 108 and/or second outer layer 110 may comprise the anti-slip material.

Heating element 104 may comprise any suitable structure(s) that is/are configured to be operatively coupled to DC power supply 106 in order to receive electrical power from DC power supply 106 and to generate a heat output to heat substrate 102. In some examples, heating element 104 comprises a resistive heating element 120 that is configured to generate the heat output by resisting electrical current flowing through heating element 104 as a result of the electrical power that is supplied by DC power supply 106 to heating element 104. Heating element 104 may comprise any suitable conductive material that is configured to generating heat, or a heat output, by its resistance to the flow of electrical current. For example, heating element 104 may be or include a graphene yarn material, a graphene mesh material, copper, nickel, chromium, aluminum, an alloy comprising the same, and/or any other suitable conductive metal. In some examples, heating element 104 comprises a conductive metal wire 122 (e.g., a copper wire). In some examples, heating element 104 comprises a single-piece structure that is configured to be operatively coupled to DC power supply 106 to form a series heating circuit 158. In some other examples, heating element 104 may comprise multiple different heating elements that each are operatively coupled to DC power supply 106 in parallel with one another.

As described further below, heating element 104 may comprise a conductive metal wire 122 and/or any other suitable conductive metal structure(s) having a known correspondence between change in electrical resistance and change in temperature. For example, copper wire is known to have approximately a 4% increase in resistance for a 10-degree Celsius increase in temperature of the copper wire. The known correspondence between change in electrical resistance of heating element 104 and change in temperature of heating element 104 is utilized by DC-powered control systems 200, as described further below, to identify when DC-heated bedding assemblies 100 are overheating and/or when DC-heated bedding assemblies 100 are at a different than expected temperature.

Heating element 104 may be coupled to and/or otherwise supported by substrate 102 in any suitable manner that is configured to facilitate heating element 104 heating substrate 102. For example, heating element 104 may be sewn, threaded, woven, disposed, adhered, deposited, and/or formed in and/or on substrate 102. FIG. 2 schematically illustrates three non-limiting example constructions of substrate 102 and heating element 104 of example DC-heated bedding assemblies 100, which are respectively indicated at 100′, 100″, and 100″′ in FIG. 2. As shown in FIG. 2, DC-heated bedding assembly 100′ comprises substrate 102 and heating element 104, which comprises conductive metal wire 122 that is sewn or woven into and/or onto one or more layers of substrate 102. For example, conductive metal wire 122 may be sewn into one or more inner layers 118 of substrate 102, such that heating element 104 is coupled to one or more inner layers 118. In such examples, first and second outer layers 108, 110 are disposed on opposing sides of one or more inner layers 118. In other words, one or more inner layers 118 and heating element 104 that is sewn into one or more inner layers 118 are sandwiched between and/or embedded within first and second outer layers 108, 110.

As shown in FIG. 2, another example DC-heated bedding assembly 100″ includes a substrate 102 and heating element 104, which comprises conductive metal wire 122 that is threaded, sewn, or otherwise positioned through a plurality of channels 124 that are formed in and/or between one or more layers of substrate 102. For example, plurality of channels 124 may be formed by stitching that connects one or more layers (e.g., first and second outer layers 108, 110) of substrate 102 to each other. The stitching may extend laterally across the one or more layers of substrate 102 (e.g., the first and second outer layers 108, 110) in rows that are spaced from each other to form plurality of channels 124. In such examples, plurality of channels 124 extend laterally across substrate 102, transverse to longitudinal axis 128 of substrate 102, and/or parallel to longitudinal axis 128, such that plurality of channels 124 extend longitudinally across substrate 102 parallel to longitudinal axis 128. Conductive metal wire 122 is sewn, threaded, or otherwise positioned through plurality of channels 124, such that conductive metal wire 122 is sandwiched between first outer layer 108 and second outer layer 110 within plurality of channels 124. The rows of stitching may be spaced apart from each other by any suitable distance to form plurality of channels 124 which are configured to receive conductive metal wire. For example, the rows of stitching may be separated by at least 0.125 inches, at least 0.25 inches, at least 0.5 inches, at least 0.75 inches, at least 1 inch, at most 5 inches, at most 3 inches, at most 2 inches, at most 1 inch, and/or at most 0.5 inches. Accordingly, plurality of channels 124 may each have a width that corresponds to a lateral, or minimum, distance between adjacent rows of stitching.

Another example DC-heated bedding assembly 100″′ is shown in FIG. 2. As shown, DC-heated bedding assembly 100″′ includes heating element 104 sandwiched between first and second outer layers 108, 110 of substrate 102. In some examples, first and second outer layers 108, 110 completely surround heating element 104. In other words, heating element 104 is embedded within substrate 102 between first and second outer layers 108, 110. As a result, first and second outer layers 108, 110 are configured to prevent heating element 104 from contacting any surfaces that are external to substrate 102 and/or any users that are in contact with substrate 102 of DC-heated bedding assembly 100″′.

Returning now to the schematic illustration of DC-heated bedding assemblies 100 shown in FIG. 1, in some examples, heating element 104 is configured to generate different heat outputs at different regions of substrate 102 to heat the different regions of substrate 102 by different degrees and/or to different temperatures. For example, heating element 104 may have two or more zones 130, each of which is supported or extends within a different region 132 of substrate 102, such as along longitudinal axis 128. In the illustrative example shown in FIG. 1, three zones 130 are shown and individually indicated as zones 130A, 130B, and 130C, with the zones 130 supported and/or extending in corresponding regions 132, which are individually indicated as regions 132A, 132B, and 132C. In such examples, at least two of two or more zones 130 are configured to generate different heat outputs to heat different regions 132 of substrate 102 that support the respective zone. In some examples in which DC-heated bedding assemblies 100 are configured to be positioned beneath a user in a supine position (e.g., when DC-heated bedding assemblies 100 comprise a DC-heated sleeping pad), heating element 104 may be configured to generate different heat outputs at different regions 132 of substrate 102 that correspond to different portions of the user's body. For example, heating element 104 may be configured to generate a greater heat output at regions 132 of substrate 102 (i.e., regions 132A and 132B) that correspond to a head position of a user or a foot position of the user when the user is positioned on top of or under substrate 102 in a supine position. In such examples, heating element 104 may be configured to generate a lesser heat output at a middle region (i.e., region 132C) of substrate 102, which is configured to be positioned beneath the user's torso when the user is positioned on top of substrate 102 in the supine position. Heating element 104 may have any other suitable combination and/or arrangement of two or more zones 130.

In the illustrative example shown in FIG. 1, two or more zones 130 of heating element comprise at least a first zone 130A that is supported by a first end region 132A of substrate 102 and a second zone 130B that is supported by a second end region 132B of substrate 102. First end region 132A and second end region 132B comprise opposing end regions of substrate 102 along longitudinal axis 128. The two or more zones 130 may further include a third zone 130C, which is supported by a middle region 132C of substrate 102. Middle region 132C of substrate 102 is disposed between first and second end regions 132A, 132B of substrate 102 along longitudinal axis 128. Accordingly, third zone 130C is disposed between first and second zones 130A, 130B of heating element 104. In some examples, first end region 132A and second end region 132B may correspond to upper and lower end regions of substrate 102 and/or, in some examples, may correspond to head and toe end regions of substrate 102.

As a non-limiting illustrative example, DC-heated bedding assemblies 100 may be configured to be positioned beneath or over a user in a supine position during use. In such examples, first end region 132A may be configured to be positioned beneath or over a user's head, second end region 132B may be configured to be positioned beneath or over the user's feet, and middle region 132C may be configured to be positioned beneath or over the user's torso when the user is disposed on top of or beneath substrate 102 in the supine position. As described above, at least two of two or more zones 130 (such as zones 130A, 130B, and 130C) of heating element 104 are configured to generate different heat outputs than each other to heat different regions 132 (such as regions 132A, 132B, and 132C) of substrate 102 by, or to, different degrees. For example, at least one of, and optionally both of, first zone 130A and second zone 130B of heating element 104 may be configured to generate a greater heat output than the heat output that is generated by third zone 130C. This facilitates heating element 104 generating greater heat outputs at region(s) of substrate 102 (e.g., first and second end regions 132A, 132B) that are configured to be positioned beneath or over the user's head and/or feet, and a lesser heat output at middle region 132C of substrate 102 configured to be positioned beneath or over the user's torso. As another example, third zone 130C may be configured to generate a greater heat output than at least one of, and optionally both of, first zone 130A and second zone 130B. First zone 130A may be configured to generate a greater heat output, a lesser heat output, at least substantially the same, and/or the same heat output as second zone 130B.

The zones 130 of substrate 102 may have any suitable length, measured parallel to longitudinal axis 128. Thus, in the example shown in FIG. 1, first zone 130A has any suitable first zone length 131A, second zone 130B has any suitable second zone length 131B, and third zone 130C has any suitable third zone length 131C, as measured along longitudinal axis 128. First, second, and third zone lengths 131A, 131B, 131C may each be any suitable length dependent on the desired heating characteristics of DC-heated bedding assemblies 100. For example, first zone length 131A and/or second zone length 131B may be at least 10 inches, at least 12 inches, at least 15 inches, at least 17 inches, at least 20 inches, at most 25 inches, at most 20 inches, at most 18 inches, at most 15 inches, at most 12 inches, and/or at most 10 inches. In some examples, third zone length may be at least 25 inches, at least 30 inches, at least 32 inches, at least 35 inches, at most 40 inches, at most 35 inches, at most 30 inches, and/or at most 25 inches. One or more of first, second, and third zone lengths 131A, 131B, 131C may be equal to each other or different than each other. For example, first zone length 131A and second zone length 131B may be equal. In some examples, third zone length 131C is greater than at least one of, and optionally both of, first zone length 131A and second zone length 131B. As a non-limiting example, first zone length 131A and second zone length 131B may be approximately 15 inches and third zone length 131C may be approximately 32 inches.

First zone 130A, second zone 130B, and third zone 130C each may have any suitable width, as measured laterally across heating element 104 and substrate 102 perpendicular to longitudinal axis 128 of substrate 102. In some examples, each of first zone 130A, second zone 130B, and third zone 130C have an equal width. The width of first zone 130A, second zone 130B, and third zone 130C may be at least 15 inches, at least 17 inches, at least 20 inches, at least 22 inches, at least 25 inches, at most 25 inches, at most 22 inches, at most 20 inches, at most 17 inches, and/or at most 15 inches. In some examples, the width of each of first zone 130A, second zone 130B, and third zone 130C is approximately 17 inches.

Similarly, first end region 132A of substrate 102 has a first end region length 133A as measured along longitudinal axis 128, second end region 132B has a second end region length 133B as measured along longitudinal axis 128, and middle region 132C has a middle region length 133C as measured along longitudinal axis 128. In some examples, substrate 102 has a substrate length 134 as measured along longitudinal axis 128 that is equal to first end region length 133A, second end region length 133B, and middle region length 133C added together. First end region length 133A, second end region length 133B, and middle region length 133C may each be any suitable length dependent on the intended use of DC-heated bedding assemblies 100. For example, first end region length 133A, second end region length 133B, and middle region length 133C when added together may be sized to be positioned underneath a user laying on top of substrate 102 in the supine position.

In some examples, first end region length 133A and/or second end region length 133B may be at least 15 inches, at least 18 inches, at least 20 inches, at least 22 inches, at most 25 inches, at most 20 inches, and/or at most 15 inches. Middle region length 133C may be at least 25 inches, at least 30 inches, at least 32 inches, at least 35 inches, at most 40 inches, at most 35 inches, at most 30 inches, and/or at most 25 inches. In some examples, at least one of, and in some examples both of, first end region length 133A and second end region length 133B are less than middle region length 133C. In some examples, first end region length 133A and second end region length 133B are equal. As a non-limiting example, first end region length 133A and second end region length 133B may be approximately 18 inches and middle region length 133C may be approximately 32 inches. In such examples, substrate length 134 may be approximately 68 inches.

First end region 132A, second end region 132B, and middle region 132C each may have any suitable width, as measured laterally across substrate 102 perpendicular to longitudinal axis 128. In some examples, each of first end region 132A, second end region 132B, and middle region 132C have an equal width. The width of first end region 132A, second end region 132B, and middle region 132C may be at least 15 inches, at least 17 inches, at least 20 inches, at least 22 inches, at least 25 inches, at most 25 inches, at most 22 inches, at most 20 inches, at most 17 inches, and/or at most 15 inches. In some examples, the width of each of first end region 132A, second end region 132B, and middle region 132C is approximately 21 inches.

FIG. 3 schematically illustrates a top plan view of an example DC-heated bedding assembly 100. In some examples, such as illustrated in FIG. 3, heating element 104 defines a sinuous path 136 which extends back and forth across and along longitudinal axis 128 of substrate 102. For example, heating element 104 may comprise conductive metal wire 122, which extends back and forth across and along longitudinal axis 128 to define sinuous path 136.

As shown in FIG. 3, in some examples, sinuous path 136 has a different density in the at least two of two or more zones 130A, 130B, 130C of heating element 104 that generate the different heat outputs. In other words, one or more of two or more zones 130A, 130B, 130C may be formed by a greater or lesser amount of heating element 104 (e.g., conductive metal wire 122) per unit length of substrate 102, as measured along longitudinal axis 128. In such examples, zones 130A, 130B, 130C of heating element 104 having a greater density are configured to generate a greater heat output than zones 130A, 130B, 130C that have a lesser density. Alternatively, in some examples, heating element 104 may not include two or more zones 130A, 130B, 130C that generate the different heat outputs, and sinuous path 136 may have a same or equal density across an entirety of heating element 104.

In some examples, such as shown in FIG. 3, the density of sinuous path 136 may be greater in at least one of, and optionally both of, first zone 130A and second zone 130B of heating element 104 than in third zone 130C. Alternatively, the density of sinuous path 136 may be greater in third zone 130C than in first and second zones 130A, 130B. In some examples, the density of sinuous path 136 in first zone 130 may be the same as, less than, or greater than the density of sinuous path 136 in second zone 130B.

Explained another way, sinuous path 136 may have a first path length 138A in first zone 130A, a second path length 138B in second zone 130B, and a third path length 138C in third zone 130C. In some examples in which heating element 104 comprises conductive metal wire 122, first path length 138A is equal to a length of conductive metal wire 122 forming first zone 130A of heating element 104, second path length 138B is equal to the length of conductive metal wire 122 forming second zone 130B, and third path length 138C is equal to the length of conductive metal wire 122 forming third zone 130C of heating element 104. First path length 138A, second path length 138B, and third path length 138C may each be any suitable length dependent on the desired density of sinuous path 136 in each of first zone 130A, second zone 130B, and third zone 130C. In some examples, at least one of, and optionally both of, first path length 138A and second path length 138B are less than third path length 138C. Alternatively, third path length 138C may be less than one or more of first path length 138A and second path length 138B or equal to one or more of first path length 138A and second path length 138B. First path length 138A may be the same as, less than, or greater than second path length 138B. As examples, first path length 138A and/or the second path length 138B may be at least 20 feet, at least 22 feet, at least 25 feet, at least 28 feet, at most 30 feet, at most 28 feet, at most 25 feet, and/or at most 22 feet. In some examples, third path length 138C may be at least 20 feet, at least 22 feet, at least 25 feet, at least 28 feet, at most 30 feet, at most 28 feet, at most 25 feet, and/or at most 22 feet. As a non-limiting example, first path length 138A and/or second path length 138B may be approximately 24 feet and third path length 138C may be approximately 25 feet.

The density of sinuous path 136 in each of zones 130A, 130B, 130C may be determined by the path length of each zone per unit length of the respective zone (e.g., the zone length), as measured along longitudinal axis 128. For example, as described above, each of first path length 138A and second path length 138B may be approximately 24 feet and each of first and second zone lengths 131A, 131B may be approximately 15 inches. Third path length 138C may be approximately 25 feet, and third zone length 131C may be approximately 32 inches. In such examples, the density of sinuous path 136 is greater in first and second zones 130A, 130B than in third zone 130C, because the path length per zone length is greater in first and second zones 130A, 130B than in third zone 130C. This facilitates first and second zones 130A, 130B of heating element 104 being configured to generate a greater heat output than third zone 130C. Alternatively, sinuous path 136 may have a greater density in third zone 130C than in first zone 130A and/or second zone 130B, such that third zone 130C of heating element 104 is configured to generate a greater heat output than first zone 130A and/or second zone 130B. Sinuous path 136 may have any suitable density in each of two or more zones 130A, 130B, 130C of heating element 104 dependent on the desired heat output of heating element 104 in the different zones.

Returning now to the schematic illustration of bed heating systems 10 illustrated in FIG. 1, As schematically illustrated in FIG. 1, bed heating systems 10 optionally further may include a wrap strap assembly 154 that is configured to selectively retain the DC-heated bedding assemblies 100 in a rolled and/or a folded configuration. In some examples, wrap strap assembly 154 is fixed to DC-heated bedding assemblies 100, such as via stitching or other permanent or fixed fastening mechanism; while in other examples, wrap strap assembly 154 is separate from DC-heated bedding assemblies 100 and/or is configured to be selectively attached to and detached from the DC-heated bedding assemblies 100, such as via one or more fasteners.

As schematically and indicated in FIG. 1, DC-heated bedding assemblies 100 optionally further may include a heating surface attachment 156 that is configured to selectively and mechanically couple DC-heated bedding assemblies 100 to heating surface 116, such as when heating surface is or includes a sleeping pad, a mattress, a car seat, etc. For example, heating surface attachment 156 may comprise one or more of a pocket that is sized to receive heating surface 116, straps configured to extend around heating surface 116, and/or fasteners configured to fasten to heating surface 116. Accordingly, heating surface attachment 156, when present, is configured to restrict DC-heated bedding assemblies 100 from inadvertently being separated from heating surface 116 during use, such as when a user tosses and turns during sleep.

Some bed heating systems 10 further may comprise heating surface 116, such as when bed heating system 10 is or includes a sleeping pad or a mattress. In some examples, heating surface 116 is configured specifically for use with DC-heated bedding assemblies 100 according to the present disclosure. In particular, heating surface 116 and substrate 102 may have the same or a substantially similar footprint (i.e., area covered or underlaid by the substrate when the substrate is in an unrolled, unfolded, or otherwise expanded use configuration). Additionally or alternatively, DC-heated bedding assemblies 100 may be configured for use with any suitably sized and shaped heating surface 116.

In some examples, bed heating systems 10 comprise DC power supply 106. DC power supply 106 may comprise any suitable direct current (DC) power supply that is configured to supply direct current (DC) electrical power to heating element 104. DC-heated bedding assemblies 100 that includes heating element 104 are configured to be utilized with any suitable DC power supply 106, such as a DC power supply that is common in many vehicles and other batteries. Heating element 104 is configured to be operatively coupled to DC power supply 106 in order to receive electrical power from DC power supply 106 and to generate the heat output to heat substrate 102. In some examples, DC power supply 106 may be a low-voltage power supply. DC power supply 106 may be a 5 volt (V) DC power supply and at most a 24V DC power supply. For example, DC power supply 106 may be a 5V DC power supply, a 6V DC power supply, a 12V DC power supply, or an 18V DC power supply.

As shown in FIG. 1, DC-heated bedding assemblies 100 are configured to be utilized with DC-powered control systems 200. DC-heated bedding assemblies 100 include one or more structures, elements, and/or components that are configured to permit DC-powered control systems 200 to monitor a voltage of heating element 104 and/or a temperature of heating element 104 and/or substrate 102. For example, DC-heated bedding assemblies 100 comprise at least one voltage tap 140 that is positioned along a length of heating element 104 at a respective voltage tap position. DC-heated bedding assemblies 100 may comprise any suitable number and arrangement of voltage taps 140 that are positioned along the length of heating element 104. For example, DC-heated bedding assemblies 100 may comprise at least 1 voltage tap, at least 2 voltage taps, at least 3 voltage taps, at least 4 voltage taps, at least 5 voltage taps, at most 5 voltage taps, at most 4 voltage taps, at most 3 voltage taps, and/or any other suitable number of voltage taps positioned along the length of heating element 104 at respective voltage tap positions. In the illustrative example shown in FIG. 1, three voltage taps 140 are shown and individually indicated at 140A, 140B, and 140C. As described further below, controller 202 of DC-powered control systems 200 is configured to be operatively coupled to each of the one or more voltage taps 140 and is configured to monitor a detected voltage of heating element 104 at each of the one or more voltage taps 140. The detected voltage at each of the one or more voltage taps 140 is with respect to ground.

In some examples, and as illustrated in FIG. 1, the one or more voltage taps 140 comprise two or more voltage taps 140A, 140B, 140C, which are operatively coupled to heating element 104 at respective voltage tap positions that are spaced apart from each other along the length of heating element 104. For example, at least two of the two or more voltage taps 140A, 140B, 140C may be operatively coupled to a different one of two or more zones 130A, 130B, 130C of heating element 104. In some examples, the at least one voltage tap comprises at least a first voltage tap 140A, which is operatively coupled to first zone 130A of heating element 104, at least a second voltage tap 140B, which is operatively coupled to second zone 130B of heating element 104, and/or at least a third voltage tap 140C, which is operatively coupled to third zone 130C of heating element 104. In some examples, first voltage tap 140A, second voltage tap 140B, and/or third voltage tap 140C may be coupled to heating element 104 at a transition between two of the two or more zones, e.g., the transition between first zone 130A and third zone 130C or at a transition between third zone 130C and second zone 130B. Each of voltage tap(s) 140A, 140B, 140C is/are configured to permit controller 202 to monitor the detected voltage of heating element 104 at the specific voltage tap position at which voltage tap(s) 140A, 140B, 140C are disposed along the length of heating element 104.

In some examples, heating element 104 does not include different zones 130 that are configured to generate different heat outputs and, in such examples, two or more voltage taps 140 may be spaced apart from each other along the length of heating element 104 in any suitable manner. As a non-limiting example, DC-heated bedding assemblies 100 may include a respective voltage tap positioned at a ⅓ position along the length of heating element 104 and/or at a ⅔ position along a length of heating element 104. In other words, heating element 104 may comprise a first end 105A and a second end 105B, and first voltage tap 140A may be positioned ⅓ of the length between first end 105A and second end 105B, and second voltage tap 140B may be positioned ⅔ of the length between first end 105A and second end 105B of heating element 104. Analogous examples may include three, four, or more spaced apart voltage taps 140 spaced along the length of heating element 104.

In some examples, DC-heated bedding assemblies 100 comprise one or more temperature sensors 142 that is/are configured to detect a temperature of substrate 102 and/or heating element 104. The one or more temperature sensors 142 are operatively coupled to heating element 104 and are configured to detect a detected temperature of heating element 104. Temperature sensor 142 may include any suitable structure, and in some examples, may be or include a thermistor. An example of a suitable thermistor is a NTC thermistor 143 that is configured to determine the detected temperature of heating element 104 based on a measured electrical resistance of heating element 104. DC-heated bedding assemblies 100 may comprise any suitable number and arrangement of temperature sensors 142. As described in more detail herein, controller 202 may be configured to be operatively coupled to each of temperature sensors 142 to monitor the detected temperature detected by the temperature sensors. In some examples, controller 202 is configured to selectively regulate the electrical power that is supplied to heating element 104 based at least in part on the detected temperature by the temperature sensors.

DC-heated bedding assemblies 100 may comprise any suitable number and arrangement of temperature sensors 142. For example, DC-heated bedding assemblies 100 may comprise at least 1 temperature sensor, at least 2 temperature sensors, at least 3 temperature sensors, at least 4 temperature sensors, at least 5 temperature sensors, at most 5 temperature sensors, at most 4 temperature sensors, at most 3 temperature sensors, and/or any other suitable number of temperature sensors positioned along the length of heating element 104. For example and as illustrated in FIG. 1, DC-heated bedding assemblies 100 may comprise 3 temperature sensors 142, such as which are illustrated individually at 142A, 142B, and 142C.

In some examples, DC-heated bedding assemblies 100 comprise two or more temperature sensors 142, such as temperature sensors 142A, 142B, 142C, which are operatively coupled to heating element 104 at respective thermistor positions that are spaced apart from each other along the length of heating element 104. For example, at least two of two or more temperature sensors 142A, 142B, 142C may be operatively coupled to a different one of two or more zones 130A, 130B, 130C of heating element 104. In some examples, the two or more temperature sensors comprise at least a first temperature sensor 142A, which is operatively coupled to first zone 130A of heating element 104, at least a second temperature sensor 142B, which is operatively coupled to second zone 130B of heating element 104, and/or at least a third temperature sensor 142C, which is operatively coupled to third zone 130C of heating element 104. In such examples, each of first, second, and/or third temperature sensors 142A, 142B, 142C is/are configured to detect the temperature of heating element 104 at the respective zone at which the temperature sensor is operatively coupled to heating element 104. Alternatively, in some examples, heating element 104 does not include different zones that are configured to generate different heat outputs, and temperature sensors 142A, 142B, 142C may be operatively coupled to heating element 104 at any suitable temperature sensors position(s) spaced apart along the length of heating element 104.

In some examples, DC-heated bedding assemblies 100 may comprise at least one mechanical thermostat 144 that is supported by substrate 102. Each of the one or more mechanical thermostats 144 is configured to detect a measured substrate temperature of substrate 102 at the location of the respective mechanical thermostat. As described further below, controller 202 is configured to be operatively coupled to each of mechanical thermostat(s) 144 to monitor the measured substrate temperature. In some examples, controller 202 is configured to selectively regulate the electrical power that is supplied to heating element 104 based on the measured substrate temperature.

DC-heated bedding assemblies 100 may comprise any suitable number and arrangement of mechanical thermostat(s) 144. For example, DC-heated bedding assemblies 100 may comprise at least 1 mechanical thermostat, at least 2 mechanical thermostats, at least 3 mechanical thermostats, at least 4 mechanical thermostats, at least 5 mechanical thermostats, at most 5 mechanical thermostats, at most 4 mechanical thermostats, at most 3 voltage taps, and/or any other suitable number of mechanical thermostat 144 that are supported by substrate 102. For example, FIG. 1 illustrates three mechanical thermostats 144 that are indicated individually at 144A, 144B, and 144C. In some examples, at least one mechanical thermostat 144 is supported by one or more of first end region 132A, second end region 132B, and/or middle region 132C of substrate 102. For example, the at least one mechanical thermostat may comprise at least a first mechanical thermostat 144A, which is supported by first end region 132A of substrate 102, at least a second mechanical thermostat 144B, which is supported by second end region 132B of substrate 102, and/or at least a third mechanical thermostat 144C, which is supported by middle region 132C of substrate. In such examples, first, second, and/or third mechanical thermostat(s) 144A, 144B, 144C are each configured to detect a local temperature of the region of substrate that supports the respective mechanical thermostat. In other words, first mechanical thermostat 144A that is supported by first end region 132A is configured to detect the measured substrate temperature of first end region 132A of substrate 102.

One or more voltage taps 140, temperature sensors 142, and/or mechanical thermostats 144 are spaced apart from each other along the length of heating element 104 and/or substrate 102 to permit DC-powered control systems 200 to identify and monitor localized or regional heating of DC-heated bedding assemblies 100, as described further below. In other words, rather than relying only on average temperature measurements over an entirety of heating element 104 and/or substrate 102, and/or average voltage measurements over an entirety of heating element 104, DC-heated bedding assemblies 100 may be configured to permit localized or regional monitoring of the temperature and/or voltage at different regions of the substrate 102 and/or heating element 104. This provides additional information that is utilized by DC-powered control systems 200 to regulate the electrical power that is supplied to heating element 104.

As shown in FIG. 1, bed heating systems 10 further may include a DC-powered control system 200. DC-powered control systems 200 comprise a controller 202, which is configured to be connected in series between DC power supply 106 and heating element 104. Controller 202 is configured to selectively regulate an electrical power that is supplied to heating element 104 by DC power supply 106. As described further below, controller 202 is configured to monitor detected voltage at various positions (e.g., voltage taps 140A, 140B, 140C) along a length of heating element 104, and to utilize the detected information to determine an amount of the electrical power to supply to heating element 104 and/or any required adjustments to the electrical power that is supplied to heating element 104.

In some examples, controller 202 is electrically connected to first end 105A and second end 105B of heating element 104 to form a series heating circuit 158, which includes an entirety of heating element 104. In such examples, series heating circuit 158 comprises DC power supply 106, heating element 104, which comprises a load that is configured to receive the electrical power and to generate a heat output by resisting electrical current flowing through heating element 104, and controller 202, connected in series between DC power supply 106 and heating element 104. Controller 202 is configured to selectively regulate or adjust the electrical power that is supplied to heating element 104 by DC power supply 106, e.g., by increasing, decreasing, or maintaining an average voltage applied across heating element 104. In such examples, controller 202 is configured to supply the same amount of electrical power to an entirety of heating element 104.

Alternatively, in some examples, controller 202 may be electrically coupled to different zones 130 of heating element 104 individually. For example, and with respect to the example of FIG. 1, controller 202 may be electrically connected to one or more of first zone 130A, second zone 130B, and/or third zone 130C of heating element 104 individually. In such examples, controller 202 may be configured to permit the supply of different amounts of electrical power to each respective zone of heating element 104 to which controller 202 is connected electrically. In such examples, controller 202 may be configured to selectively adjust the heat output that is generated by each different zone of heating element 104 by increasing or decreasing the electrical power that is supplied to the different zones of heating element 104.

In some examples, heating element 104 may comprise multiple different heating elements 104 connected in parallel with one another, and controller 202 may be electrically connected to each of the multiple different heating elements. In such examples, controller 202 may be configured to apply the same electrical power to each of the multiple different heating elements.

Controller 202 may comprise any suitable hardware and/or software that is configured to facilitate controller 202 receiving one or more inputs (e.g., a user's desired heat output, a detected voltage, a detected temperature, a measured substrate temperature, a detected electrical current, etc.) and generating one or more corresponding output commands or control functions for controlling the electrical power that is supplied to heating element 104 by DC power supply 106. As a non-limiting example, controller 202 may comprise any suitable signal conditioning and/or analog circuit 208, a power control device 210, a user interface 203, and/or a microcontroller 212.

In some examples, controller 202 comprises signal conditioning and/or analog circuits 208 that are configured to facilitate controller 202 monitoring an electrical current flowing through heating element 104, one or more detected voltages at one or more voltage tap(s) 140, and/or detected temperatures at one or more temperature sensors 142, and/or one or more mechanical thermostat(s) 144. For example, signal conditioning and/or analog circuits 208 may comprise an analog-to-digital converter (ADC), which is configured to receive analog signals of a detected electrical current, detected voltages, and/or detected temperatures and to manipulate the signal in order to be analyzed by microcontroller 212. Microcontroller 212 is configured to evaluate a user's input desired temperature, the detected electrical current, the detected voltages, and/or the detected temperatures and to execute one or more algorithms and/or software programs in order to determine an appropriate output based on the input desired temperature. For example, microcontroller 212 may signal to power control device 210 an appropriate amount of electrical power to supply to heating element 104 based on the input desired temperature. Power control device 210 is configured to selectively regulate the electrical power that is supplied to heating element 104 based on one or more control signals from microcontroller 212.

In some examples, controller 202 is configured to be handheld (i.e., shaped and sized to be held and supported in a user's hand), and controller 202 may be configured to receive a user input indicating a desired heat output by heating element 104. Controller 202 may be configured to enable the user to select a desired input from a plurality of predefined desired heat outputs (such as incrementally different heat outputs that are individually selected) and/or a continuous range of heat outputs within which the desired heat output is selected. In some examples, controller 202 includes user interface 203, which is configured to permit the user to provide the user input. In such examples, controller 202 may be configured to calculate a required electrical power to be supplied to heating element 104 in order to generate the user's desired heat output and to supply the required electrical power to heating element 104. Alternatively, in some examples, controller 202 may have stored values of the required electrical power that is required to be supplied to heating element 104 to generate different desired temperatures of the user.

As shown in FIG. 1, controller 202 may comprise an electric connector 204, such as a jack, a port, a plug, or a cord that is configured to electrically connect controller 202 to DC power supply 106. For example, electric connector 204 may comprise a USB port or USB cord, a USB-C port or USB-C cord, a USB-CPD port or USB-CPD cord, and/or any other suitable connector. Controller 202 is configured to be electrically connected to heating element 104 in any suitable manner, such that controller 202 is connected electrically in series between DC power supply 106 and heating element 104. For example, controller 202 may comprise and/or be electrically connected (e.g., by an electrical wire) to a multi-pin connector 206, which is configured to electrically connect controller 202 to heating element 104, and in some examples, electrically connect controller 202 to one or more voltage tap 140, temperature sensors 142, and/or one or more thermostats 144 positioned along a length of heating element 104 and/or substrate 102 in order to monitor detected temperatures and/or detected voltages at each of voltage taps, temperature sensors, and/or thermostats. In some examples, controller 202 is further configured to detect and/or monitor a total voltage applied across heating element 104 and an electrical current flowing through heating element 104.

DC-powered control systems 200 may be configured to monitor the voltage, temperature, and/or electrical current at different positions of heating element 104 to prevent overheating of DC-heated bedding assemblies 100. As an example, if a portion of heating element 104 is folded, bunched, or rolled, this may result in a significant increase of temperature in the portion in comparison to an expected temperature of the portion, whereas portions of heating element 104 that are not folded, bunched, or rolled may be at the expected temperature. Because only a subset of heating element 104 is a higher temperature than the expected temperature, determining the average temperature of heating element 104 over an entirety of heating element 104 may not provide sufficient evidence or indicate to DC-powered control systems 200 that heating element 104 is at the higher temperature than the expected temperature in the folded, bunched, or rolled portion.

Accordingly, as described further below, DC-powered control systems 200 may be configured to monitor heating element 104 using one or more voltage taps 140, one or more temperature sensors 142, and/or one or more thermostats 144 that are positioned along the length of heating element 104 and/or substrate 102 in order to identify unexpected temperatures at different regions along the length of heating element 104 and/or substrate 102. In other words, DC-powered control systems 200 may be configured to utilize data collected at the one or more voltage taps 140, the one or more temperature sensors 142, and/or the one or more thermostats 144 to determine the state (e.g., temperature) of the different regions along the length of heating element 104 and/or substrate 102 and to selectively regulate the electrical power that is supplied to heating element 104 based on the determined state of the different regions. By monitoring the state of the different regions along the length of heating element 104 and/or substrate 102, DC-powered control systems 200 may be configured to facilitate preheating of DC-heated bedding assemblies 100 when the DC-heated bedding assemblies are in a sheet-like use configuration, in a partially rolled and/or folded configuration, in an at least substantially rolled and/or folded configuration, and/or in a completely rolled and/or folded positions. Furthermore, DC-powered control systems 200 are configured to utilize data collected at the one or more voltage taps 140, one or more temperature sensors 142, and/or one or more thermostats 144 to selectively regulate the electrical power that is supplied to heating element 104 in order to ensure DC-heated bedding assemblies 100 are heated to and are maintained at the user's desired temperature.

In some examples, controller 202 is configured to utilize a known correspondence between change in resistance and change in temperature of heating element 104 to identify localized overheating of heating element 104. In examples in which controller 202 is electrically connected to first end 105A and second end 105B of heating element 104 and is configured to supply the same amount of electrical power over an entirety of heating element 104, the electrical current is the same throughout the entirety of heating element 104 at any specific time. Specifically, the electrical current throughout heating element 104 is determined by the voltage difference across heating element 104 and the total resistance of heating element 104. However, in some examples, the resistance of heating element 104 may be different at different zones of heating element 104. In other words, heating element 104 may not have a uniform resistance across an entire length of heating element 104. For example, a portion of heating element 104 that is partially rolled and/or folded may be at a higher temperature, and therefore have a higher resistance, than a different portion of heating element 104 that is flat or straight.

As described above, heating element 104 may comprise conductive metal wire 122 (e.g., a copper metal wire), which has a known correspondence between change in electrical resistance and change in temperature. For example, the electrical resistance of a copper wire is known to increase by approximately 0.393% per degree Celsius increase in temperature of the copper wire. In other words, the electrical resistance of copper wire increases by approximately 4% for every 10 degrees Celsius increase in temperature of the copper wire. Other materials that may form conductive metal wire 122 (e.g., nickel, graphene, aluminum, iron, etc.) also may have known relationships between changes in temperature and changes in resistance. Using the known correspondence between change in electrical resistance and temperature of heating element 104, controller 202 is configured to identify an unexpected temperature of heating element 104 at the location of any one of voltage tap(s) 140 based on the detected voltage at the respective voltage tap(s). For example, voltage drop would be greater than expected across a section of heating element 104 having a greater electrical resistance than expected. Thus, different than expected voltages at one or more voltage tap(s) 140 may indicate a different than expected electrical resistance of one or more sections of heating element 104 and a different than expected temperature of the one or more sections of heating element 104.

FIG. 4 is a flow chart illustrating examples of control methods and/or processes 300 that are implemented by DC-powered control systems 200 (i.e., that control systems 200 are programmed and/or otherwise configured to execute) to selectively control electrical power supplied to a heating element (e.g., heating element 104 of DC-heated bedding assemblies 100). In some examples, as illustrated in FIG. 1, DC-powered control systems 200 are configured to implement steps of control methods 300 in order to selectively control the electrical power that is supplied to DC-heated bedding assemblies 100 by DC power supply 106. In the description of FIG. 4 below, DC-powered control systems 200 are described as performing the steps of control methods 300 in conjunction with DC-heated bedding assemblies 100. However, DC-powered control systems 200 implementing the control steps of control methods 300 may be utilized to control the supply of electrical power to other DC-powered heating elements for other DC-heated devices.

As shown in FIG. 4, in some examples, optional step 301 of control methods 300 includes a controller, such as previously discussed controller 202, identifying a type of DC-heated bedding assembly, such as DC-heated bedding assembly 100 (e.g., sleeping pad, blanket, etc.) to which controller 202 is connected. In some examples, controller 202 is configured to be connected to a plurality of different types of DC-heated bedding assemblies 100. In such examples, controller 202 may be configured to identify the type of the DC-heated bedding assembly 100 by detecting one or more features of the DC-heated bedding assembly 100. For example, controller 202 may be configured to identify the specific type of DC-heated bedding assembly 100 to which controller 202 is connected based on a number and arrangement of voltage tap(s) of the DC-heated bedding assembly 100. In some examples, controller 202 may have stored information regarding the DC-heated bedding assembly 100 that is identified in step 301. For example, controller 202 may have stored information regarding the length of heating element 104 of the identified DC-heated bedding assembly 100, whether the heat element 104 has two or more zones 130 that are configured to generate different heat outputs, and/or material properties of heating element 104, such as a known correspondence between change in electrical resistance and change in temperature of heating element 104. Controller 202 may utilize this information to determine an amount of electrical power to supply to heating element 104 in different circumstances and/or to achieve different heat outputs of the identified DC-heated bedding assembly 100.

As shown in FIG. 4, in some examples, step 302 of control methods 300 includes controller 202 receiving a user input indicating a desired heat output of heating element 104. In such examples, controller 202 may comprise a user interface 203. User interface 203 facilitates the user inputting the user input indicating the desired heat output. The user input and the desired heat output may be a specific desired temperature of substrate 102 or a specific desired heat output of heating element 104 (e.g., 100 degrees Celsius). Alternatively, the user input and the desired heat output may be a preset heat level (e.g., heat level 1, 2, 3, 4, etc.) corresponding to a specific desired temperature of substrate 102.

In response to receiving the user input indicating the desired heat output of heating element 104 in step 302, step 304 of control methods 300 includes controller 202 supplying a corresponding electrical power to heating element 104 that corresponds to the user's desired heat output. In some examples, step 304 may include calculating a corresponding electrical power that is required to be supplied to heating element 104 for heating element 104 to generate the desired heat output. Alternatively, controller 202 may have stored electrical power levels that correspond to the different possible user inputs for desired heat outputs.

Step 306 of methods 300 includes controller 202 monitoring a detected voltage at each of one or more voltage tap(s) 140A, 140B, and/or 140C positioned along a length of heating element 104 and/or monitoring a detected or measured temperature of heating element 104 and/or substrate 102 that is detected by each of one or more temperature sensors 142, 142C and/or one or more thermostats 144. In other words, controller 202 is configured to monitor information detected by each of the one or more voltage taps 140, one or more temperature sensors 142, and/or one or more thermostats 144 when supplying the corresponding electrical power to heating element 104, during use. Controller 202 is configured to continuously monitor the detected voltages and/or detected or measured temperatures during use. Controller 202 is configured to selectively regulate and/or adjust the electrical power that is supplied to heating element 104 based on the detected voltage at each of the one or more voltage taps 140, based on the detected temperature that is detected by each of the one or more temperature sensors 142, and/or based on the measured substrate temperature detected by each of the one or more mechanical thermostats 144, as described further below.

Step 308 of methods 300 includes controller 202 calculating and/or otherwise detecting a deviation between the detected voltage at the one or more voltage taps 140 and an expected voltage at the one or more voltage taps 140. For example, controller 202 may be configured to calculate the expected voltage at each voltage tap 140 based on the voltage tap position of the respective voltage tap along the length of heating element 104, based on an expected resistance of heating element 104, and based on the corresponding electrical power that is being supplied to heating element 104 at that time.

After calculating the expected voltage at each of voltage taps 140, controller 202 may be configured to calculate or otherwise detect the deviation between the detected voltage at voltage taps 140 and the expected voltage at the voltage taps. Controller 202 may be configured to selectively regulate the electrical power that is supplied to heating element 104 based on the value of the deviation, as described in steps 310-316 of methods 300 below.

Step 310 of methods 300 is performed by controller 202 in response to the deviation between expected voltage and detected voltage at each of the one or more voltage taps 140 less than a minimum deviation percentage of the expected voltage. In response to the deviation being less than the minimum deviation percentage at each of the one or more voltage taps 140, controller 202 is configured to continue to supply the corresponding electrical power to heating element 104 and is configured to continue to monitor the detected voltage at each of the one or more voltage taps 140. In other words, in response to the deviation being less than the minimum deviation percentage, controller 202 may be configured to return to step 306 of methods 300 and may be configured to continue to monitor the detected voltage at each of the one or more voltage taps 140.

The minimum deviation percentage may comprise any suitable percentage of the expected voltage that indicates to controller 202 that heating element 104 is at, or approximately at, an expected temperature of heating element 104. In some examples, the minimum deviation percentage comprises at least 1% of the expected voltage, at least 3% of the expected voltage, at least 5% of the expected voltage, at least 8% of the expected voltage, at least 10% of the expected voltage, at least 15% of the expected voltage, at least 20% of the expected voltage, at least 25% of the expected voltage, at most 25% of the expected voltage, at most 20% of the expected voltage, at most 15% of the expected voltage, at most 10% of the expected voltage, and/or at most 5% of the expected voltage.

Controller 202 may be configured to perform step 312 of methods 300 in response to the deviation between the expected voltage and the detected voltage at one or more of voltage tap(s) 140A, 140B, 140C being between the minimum deviation percentage and a maximum deviation percentage of the expected voltage. In other words, controller 202 may be configured to perform step 312 in response to the deviation being greater than or equal to the minimum deviation percentage and less than the maximum deviation percentage. In response to the deviation being between the minimum deviation percentage and the maximum deviation percentage, controller 202 may be configured to reduce the electrical power that is supplied to heating element 104 without ceasing to supply the electrical power to heating element 104. In some specific examples, controller 202 may be configured to increase the electrical power that is supplied to heating element 104 responsive to the deviation being between the minimum deviation percentage and the maximum deviation percentage.

In examples in which controller 202 monitors more than one voltage tap 140 along the length of heating element 104, controller 202 may be configured to reduce the electrical power that is supplied to heating element 104 responsive to the deviation between the detected voltage and the expected voltage at any one of the one or more voltage taps 140 being between the minimum and maximum deviation percentages. In some examples, controller 202 may only be configured to supply a same electrical power to an entirety of heating element 104. In such examples, controller 202 is configured to reduce the electrical power that is supplied to the entirety of heating element 104 in response to the deviation between the detected voltage and the expected voltage at any of the one or more voltage taps 140 being between the minimum and maximum deviation percentages. Alternatively, in some examples, controller 202 may be electrically connected to individual different zones 130 (e.g., two or more of zones 130A, 130B, 130C) of heating element 104, and controller 202 may be configured to supply different amounts of electrical power to each of the individual different zones. In such examples, controller 202 may be configured to reduce the electrical power that is supplied to only one of the individual different zones of heating element 104, e.g., the individual zone at which the deviation between the detected and expected voltages is between the minimum and maximum deviation percentages.

The deviation being between the minimum deviation percentage and the maximum deviation percentage indicates to controller 202 that the detected voltage, and therefore the temperature of heating element 104, is different than expected, and in many examples, greater than expected, (e.g., as a result of asymmetrical rolling and/or folding of heating element 104). The maximum deviation percentage may comprise any suitable percentage of the expected voltage that is greater than the minimum deviation percentage. For example, the maximum deviation percentage of the expected voltage may comprise at least 5% of the expected voltage, at least 10% of the expected voltage, at least 15% of the expected voltage, at least 20% of the expected voltage, at least 25% of the expected voltage, at least 30% of the expected voltage, at least 40% of the expected voltage, at least 45% of the expected voltage, at most 50% of the expected voltage, at most 40% of the expected voltage, at most 30% of the expected voltage, and/or at most 20% of the expected voltage. The minimum deviation percentage is greater than 0% of the expected voltage and less than the maximum deviation percentage.

In response to the deviation being between the minimum deviation percentage and the maximum deviation percentage, controller 202 may be configured to reduce (or alternatively in some examples increase) the electrical power that is supplied to heating element 104 by any suitable amount dependent on the deviation between the expected voltage and the detected voltage. For example, controller 202 may reduce the electrical power that is supplied to heating element 104 by at least 5%, at least 10%, at least 15%, at least 20%, at least 25%, at least 30%, at least 40%, at most 50%, at most 40%, at most 30%, at most 25%, at most 20%, and/or at most 10% without ceasing supplying the electrical power to heating element 104.

In response to the deviation being greater than or equal to the maximum deviation percentage of the expected voltage, controller 202 may be configured to perform step 314 of methods 300. In step 314, controller 202 is configured to cease supplying the electrical power to heating element 104 in response to the deviation being greater than or equal to the maximum deviation percentage of the expected voltage. The deviation being greater than or equal to the maximum deviation percentage indicates to controller 202 that the temperature of heating element 104 is far greater (or in some other examples, less than) the expected temperature of heating element 104, and therefore, that DC-heated bedding assembly 100 is not functioning as expected. By ceasing to supply electrical power to heating element 104 in response to the deviation being greater than or equal to the maximum deviation percentage of the expected voltage, controller 202 is configured to prevent overheating of DC-heated bedding assemblies 100.

In some examples, controller 202 further is configured to regulate the electrical power that is supplied to heating element 104 based on one or more of the detected temperature that is detected by one or more of temperature sensors 142 and/or based on the measured substrate temperature, which is detected by one or more of mechanical thermostat 144. For example, step 316 of methods 300 may comprise controller 202 reducing without ceasing or, in some examples, altogether ceasing the electrical power that is supplied to heating element 104 in response to one or more of the detected temperatures and/or measured substrate temperatures exceeding a maximum permitted temperature. Step 316 of methods 300 may be performed by controller 202 simultaneously to steps 310-314 of methods 300 and/or at overlapping time intervals.

In some examples, controller 202, in step 316, is configured to reduce the electrical power that is supplied to heating element 104, without ceasing to supply the electrical power to heating element 104, in response to the detected temperature that is detected by a respective one of one or more temperature sensors 142 exceeding an expected temperature by at least a threshold percentage of the expected temperature. For example, controller 202 may be configured to determine the expected temperature to be detected by each of one or more temperature sensor 142 based on the electrical power that is supplied to the heating element and a position at which the respective temperature sensor 142 is operatively coupled to heating element 104. In response to the detected temperature at one or more of temperature sensor 142 exceeding the expected temperature by at least a threshold percentage of the expected temperature, controller 202 may be configured to reduce the electrical power that is supplied to heating element 104 by any suitable amount. In some examples of step 316, controller 202 is configured to cease supplying the electrical power to heating element 104 completely in response to the detected temperature exceeding a maximum permitted temperature or in response to the detected temperature deviating from the expected temperature by more than a maximum permitted temperature deviation. In some examples of step 316, controller 202 is further configured to cease supplying the electrical power to heating element 104 in response to the measured substrate temperature detected by at least one of mechanical thermostats 144 exceeding a maximum substrate temperature.

FIG. 5 illustrates an example bed heating system 10 that includes a plurality 101 of DC-heated bedding assemblies 100. As shown in FIG. 5, the plurality 101 of DC-heated bedding assemblies 100 may comprise at least a first DC-heated bedding assembly 100A and a second DC-heated bedding assembly 100B that are operatively coupled to each other. In FIG. 5, only a pair of DC-heated bedding assemblies 100 are illustrated, however, bed heating systems 10 may comprise any suitable number of coupled together DC-heated bedding assemblies. In some examples, each DC-heated bedding assembly 100 of the plurality 101 of DC-heated bedding assemblies may comprise a coupling system 146 that is configured to selectively couple together at least two of the DC-heated bedding assemblies of the plurality, e.g., first DC-heated bedding assembly 100A and second DC-heated bedding assembly 100B. Accordingly, a selection of two or more DC-heated bedding assemblies 100A, 100B of the plurality 101 of DC-heated bedding assemblies may be coupled together to define a larger footprint, such as for operative use by more than one user. In some examples, coupling system 146 may comprise one or more fasteners 148 that are positioned along one or more edge regions 151 of substrate 102, such as along one or both long edges of substrate 102 and/or along one or both short edges of substrate 102. Fasteners 148 may comprise one or more of snaps, zippers, side-release buckles, buttons, hook-and-loop fasteners, toggle stoppers, ties, and/or magnets.

Additionally or alternatively, and as schematically represented in FIG. 5, coupling system 146 may comprise a coupling panel 150 that is configured to be fastened between, and thus interconnect, at least two DC-heated bedding assemblies 100 of the plurality 101 of DC-heated bedding assemblies. Coupling panel 150, when present, may itself be described as a fastener 148 and/or may comprise fasteners 148 that are positioned, oriented, and/or configured to selectively interconnect with corresponding fasteners 148 on the at least two DC-heated bedding assemblies 100. Although not required, coupling panel 150 may extend a full longitudinal length, or substantially the full longitudinal length, of the at least two connected DC-heated bedding assemblies 100. In some examples, an entirety and/or one or more portions of coupling panel 150 may be constructed of a non-slip material, similarly to one or more portions and/or an entirety of substrate 102, as described above. A coupling panel 150 may have a width that maintains the at least two connected DC-heated bedding assemblies 100 in close proximity to each other, or a width that spaces the at least two DC-heated bedding assemblies 100 away from each other. As examples, a coupling panel 150 may have a width of at least 2 centimeters (cm), at least 5 cm, at least 10 cm, at least 15 cm, at least 20 cm, at least 30 cm, at least 40 cm, at least 50 cm, at most 150 cm, at most 100 cm, at most 75 cm, at most 50 cm, at most 25 cm, and/or at most 15 cm.

In some examples, at least one of fasteners 148 on one or multiple of the plurality 101 of DC-heated bedding assemblies 100 and/or on coupling panel 150 (when present) are electrically coupled to heating element(s) 104 of one or multiple of the plurality 101 of DC-heated bedding assemblies 100 and/or to one or multiple controllers 202 of DC-powered control systems 200. Accordingly, heating elements 104 of two adjacent and coupled together DC-heated bedding assemblies (e.g., first and second DC-heated bedding assemblies 100A, 100B) may be electrically coupled to each other and optionally controlled by a single controller 202. That is, in some examples, a single controller 202 is configured to be operatively coupled to heating elements 104 of both first and second DC-heated bedding assemblies 100A, 100B via one or more fasteners 148. Additionally or alternatively, first and second DC-heated bedding assemblies 100A, 100B may comprise a plug or a port that is configured to operatively and electrically couple together heating elements 104 of the first and second adjacently positioned DC-heated bedding assemblies 100A, 100B.

As also schematically represented in FIG. 5, in some examples of bed heating systems 10, coupling system 146 comprises a junction 152 that is coupled to or configured to be operatively coupled to heating elements 104 of each of first and second DC-heated bedding assemblies 100A, 100B. Junction 152 is further configured to be operatively coupled to DC power supply 106 for operative powering of both first and second DC-heated bedding assemblies 100A, 100B using a single DC power supply 106. That is, two or more DC-heated bedding assemblies 100A, 100B of the plurality 101 of DC-heated bedding assemblies 100 may be configured to be operatively powered by a single DC power supply 106 via a junction 152. In other words, junction 152 may be configured to operatively couple together a plurality 101 of DC-heated bedding assemblies 100 (e.g., first and second DC-heated bedding assemblies 100A, 100B) for operative powering with a single DC power supply 106. In some such examples, one or more controllers 202 of one or more DC-powered control systems 200 are configured to be operatively coupled to junction 152.

In some examples of bed heating systems 10, the plurality 101 of DC-heated bedding assemblies 100 (e.g., first and second DC-heated bedding assemblies 100A, 100B) are configured to be coupled to a single DC power supply 106 in series and/or in parallel. In some examples, each of the DC-heated bedding assemblies (e.g., first and second DC-heated bedding assemblies 100A, 100B) of the plurality 101 of DC-heated bedding assemblies 100 are configured to be coupled to a distinct DC power supply 106. That is, each of first and second DC-heated bedding assemblies 100A, 100B may be configured to receive electrical power from its own DC power supply 106, and/or each of first and second DC-heated bedding assemblies 100A, 100B may be configured to receive the electrical power together from a single DC power supply 106. In some examples, a single DC-powered control system 200 including a single controller 202 is configured to operatively control the electrical power that is supplied to heating elements 104 of each of DC-heated bedding assemblies 100A, 100B that are operatively coupled together, whether with individual DC power supplies 106 or with a single DC power supply 106. Alternatively, multiple DC-powered control systems 200 each having a respective controller 202 may be utilized to regulate the electrical power that is supplied to each DC-heated bedding assembly 100 of the plurality 101 of DC-heated bedding assemblies individually.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material.

As another example, a first length that is at least substantially as long as a second length includes first lengths that are within 75% of the second length and also includes first lengths that are as long as the second length.

Illustrative, non-exclusive examples of bed heating systems 10 including DC-heated bedding assemblies and/or DC-powered control systems 200 according to the present disclosure are presented in the following enumerated paragraphs.
A. A bed heating system, comprising:
a DC-heated bedding assembly, comprising:
   a substrate; and
   a heating element supported by the substrate, wherein the heating element is configured to be operatively coupled to a DC power supply and to generate a heat output to heat the substrate; and
a controller configured to be connected in series between the DC power supply and the heating element, wherein the controller is configured to selectively regulate an electrical power supplied to the heating element to control the heat output generated by the heating element.
A1. The bed heating system of paragraph A, wherein the DC-heated bedding assembly is configured to be positioned at least one of on, under, and over a heating surface.
A1.1. The bed heating system of paragraph A1, wherein the heating surface is or includes a sleeping pad, a mattress, an air mattress, a cot, a car seat, a sleeping bag, a tent floor, a ground surface, a textile material, a fabric material, and/or a foam material.
A2. The bed heating system of any of paragraphs A-A1.1, wherein the substrate includes a fabric material.
A2.1. The bed heating system of any of paragraphs A-A2, wherein the substrate includes a microsuede material.
A2.2. The bed heating system of any of paragraphs A-A2.1, wherein the substrate includes one or more anti-slip sections configured to restrict the substrate from slipping relative to a/the heating surface.
A2.3. The bed heating system of any of paragraphs A-A2.2, wherein the heating element is sewn, threaded, woven, disposed, adhered, deposited, and/or formed in and/or on the substrate.
A3. The bed heating system of any of paragraphs A-A1.1, wherein the substrate comprises:
a first outer layer; and
a second outer layer;
wherein the heating element is disposed between the first outer layer and the second outer layer.
A3.1. The bed heating system of paragraph A3, wherein the first outer layer comprises a microsuede material.
A3.2. The bed heating system of any of paragraphs A3-A3.1, wherein the second outer layer comprises a/the microsuede material.
A3.3. The bed heating system of any of paragraphs A3-A3.2, wherein one or both of the first outer layer and the second outer layer comprises one or more anti-slip sections configured to restrict the substrate from slipping relative to a/the heating surface.
A3.4. The bed heating system of any of paragraphs A3-A3.3, wherein the substrate further comprises one or more inner layers disposed between the first outer layer and the second outer layer.
A3.4.1. The bed heating system of any of paragraphs A3-A3.4, wherein the heating element is supported on a/the one or more inner layers.
A3.4.2. The bed heating system of paragraph A3.4.1, wherein the heating element is sewn, threaded, woven, disposed, adhered, deposited, and/or formed in and/or on the one or more inner layers.
A4. The bed heating system of any of paragraphs A-A3.4.2, wherein the heating element comprises a resistive heating element.
A4.1. The bed heating system of any of paragraphs A-A4, wherein the heating element comprises one or more of a graphene yarn material and a wire.
A5. The bed heating system of any of paragraphs A-A4.1, wherein the substrate has a longitudinal axis, wherein the heating element has two or more zones, each supported by a different region of the substrate along the longitudinal axis, and wherein at least two of the two or more zones are configured to generate different heat outputs to heat the different regions.
A5.1. The bed heating system of paragraph A5, wherein the two or more zones comprise at least a first zone and a second zone, wherein the first zone is supported by a first end region of the substrate and the second zone is supported by a second end region of the substrate, and wherein the first end region opposes the second end region.
A5.2. The bed heating system of paragraph A5.1, wherein the two or more zones further comprise a third zone supported by a middle region of the substrate, and wherein the middle region is disposed between the first end region and the second end region along the longitudinal axis of the substrate.
A5.3. The bed heating system of paragraph A5.2, wherein the heat output generated by at least one of, and optionally both of, the first zone and the second zone is greater than the heat output generated by the third zone.
A5.4. The bed heating system of any of paragraphs A5.2-A5.3, wherein the first zone has a first zone length as measured along the longitudinal axis, the second zone has a second zone length as measured along the longitudinal axis, and the third zone has a third zone length as measured along the longitudinal axis.
A5.5. The bed heating system of paragraph A5.4, wherein the first zone length and the second zone length are at least substantially equal, and optionally are equal.
A5.6. The bed heating system of paragraph A5.4 or A5.5, wherein the third zone length is greater than the first zone length and the second zone length.
A5.7. The bed heating system of any of paragraphs A5.4-A5.6, wherein the first zone length and/or the second zone length is at least 10 inches, at least 12 inches, at least 15 inches, at least 17 inches, at least 20 inches, at most 25 inches, at most 20 inches, at most 18 inches, at most 15 inches, at most 12 inches, and/or at most 10 inches.
A5.8. The bed heating system of any of paragraphs A5.4-A5.6, wherein the first zone length and/or the second zone length are approximately 15 inches.
A5.9. The bed heating system of any of paragraphs A5.4-A5.8, wherein the third zone length is at least 25 inches, at least 30 inches, at least 32 inches, at least 35 inches, at most 40 inches, at most 35 inches, at most 30 inches, and/or at most 25 inches.
A5.10. The bed heating system of any of paragraphs A5.4-A5.8, wherein the third zone length is approximately 32 inches.
A5.11. The bed heating system of any of paragraphs A5.2-A5.10, wherein the first end region has a first end region length as measured along the longitudinal axis, the middle region has a middle region length as measured along the longitudinal axis, and the second end region has a second end region length as measured along the longitudinal axis.
A5.12. The bed heating system of paragraph A5.11, wherein the first end region length and the second end region length are at least substantially equal, and optionally are equal.
A5.13. The bed heating system of paragraph A5.11 or A5.12, wherein the middle region length is greater than the first end region length and the second end region length.
A5.14. The bed heating system of any of paragraphs A5.11-A5.13, wherein the first end region length and/or the second end region length is at least 15 inches, at least 18 inches, at least 20 inches, at least 22 inches, at most 25 inches, at most 20 inches, and/or at most 15 inches.
A5.15. The bed heating system of any of paragraphs A5.11-A5.14, wherein the middle region length is at least 25 inches, at least 30 inches, at least 32 inches, at least 35 inches, at most 40 inches, at most 35 inches, at most 30 inches, and/or at most 25 inches.
A5.16. The bed heating system of any of paragraphs A5.11-A5.15, wherein the first end region length and/or the second end region length is approximately 18 inches.
A5.17. The bed heating system of any of paragraphs A5.11-A5.16, wherein the middle region length is approximately 32 inches.
A5.18. The bed heating system of any of paragraphs A5.11-A5.17, wherein a substrate length of the substrate along the longitudinal axis is equal to the first end region length, the middle region length, and the second end region length added together.
A6. The bed heating system of any of paragraphs A-A5.18, wherein the heating element defines a sinuous path extending back and forth across and/or along a/the longitudinal axis of the substrate.
A6.1. The bed heating system of paragraph A6 when depending from any of paragraphs A5.2-A5.18, wherein the sinuous path has a different density in the at least two of the two or more zones that generate the different heat outputs.
A6.2. The bed heating system of paragraph A6.1, wherein the sinuous path is denser in at least one of, and optionally both of, the first zone and the second zone than in the third zone.
A6.3. The bed heating system of any of paragraphs A6.2, wherein the sinuous path has an at least substantially equal, and optionally an equal, density in the first zone and the second zone.
A6.4. The bed heating system of any of paragraphs A6.1-A6.3, wherein the sinuous path has a first path length in the first zone, a second path length in the second zone, and a third path length in the third zone.
A6.5. The bed heating system of paragraph A6.4, wherein the first path length is at least substantially equal to, and optionally is equal to, to the second path length.
A6.6. The bed heating system of paragraph A6.4 or A6.5, wherein the third path length is greater than the first path length and the second path length.
A6.7. The bed heating system of paragraph A6.4 or A6.5, wherein the third path length is equal to the first path length and the second path length.
A6.8. The bed heating system of any of paragraphs A6.4-A6.7, wherein the first path length and/or the second path length is at least 20 feet, at least 22 feet, at least 25 feet, at least 28 feet, at most 30 feet, at most 28 feet, at most 25 feet, and/or at most 22 feet.
A6.9. The bed heating system of any of paragraphs A6.4-A6.7, wherein the first path length and/or the second path length is approximately 24 feet.
A6.10. The bed heating system of any of paragraphs A6.4-A6.9, wherein the third path length is at least 20 feet, at least 22 feet, at least 25 feet, at least 28 feet, at most 30 feet, at most 28 feet, at most 25 feet, and/or at most 22 feet.
A6.11. The bed heating system of any of paragraphs A6.4-A6.9, wherein the third path length is approximately 25 feet.
A7. The bed heating system of any of paragraphs A-A6.11, wherein the DC-heated bedding assembly is or includes a DC-heated sleeping pad, a DC-heated blanket, a DC-heated sleeping bag, a DC-heated mattress cover, or a DC-heated seat cover.
A8. The bed heating system of any of paragraphs A-A7, wherein the DC-heated bedding assembly is configured to be selectively and repeatedly rolled, folded, and straightened.
A9. The bed heating system of any of paragraphs A-A8, further comprising the DC power supply.
A9.1. The bed heating system of paragraph A9, wherein the DC power supply is at least a 5V DC power supply and at most a 24V DC power supply.
A9.2. The bed heating system of paragraph A9.1, wherein the DC power supply is at least one of a 5V DC power supply, a 6V DC power supply, a 12V DC power supply, and an 18V DC power supply.
A10. The bed heating system of any of paragraphs A-A9.2, wherein the controller comprises an electric connector configured to electrically connect the DC-heated bedding assembly to the DC power supply.
A10.1. The bed heating system of paragraph A10, wherein the electric connector comprises one of a jack, a port, a plug, or a cord.
A10.2. The bed heating system of paragraph A10, wherein the electric connector comprises a USB cord, a USB-C cord, or a USB-CPD cord.
A10.3. The bed heating system of paragraph A10, wherein the electric connector comprises a USB port, a USB-C port, or a USB-CPD port.
A11. The bed heating system of any of paragraphs A-A10.3, wherein the controller is configured to selectively receive a user input indicating a desired heat output by the heating element.
A11.1. The bed heating system of paragraph A11, wherein the controller is configured to calculate a required electrical power to be supplied to the heating element to generate the desired heat output.
A11.2. The bed heating system of paragraph A11.1, wherein the controller is configured to supply the required electrical power to the heating element in response to receiving the user input.
A11.3. The bed heating system of any of paragraphs A11-A11.2, wherein the controller comprises a user interface configured to permit a user to provide the user input.
A11.4. The bed heating system of any of paragraphs A11-A11.3, wherein the controller is sized to be handheld.
A12. The bed heating system of any of paragraphs A-A11.4, further comprising at least one voltage tap positioned along a length of the heating element, wherein the controller is operatively coupled to the at least one voltage tap and is configured to monitor a detected voltage at the at least one voltage tap, and wherein the controller is configured to selectively regulate the electrical power supplied to the heating element based on the detected voltage.
A12.1. The bed heating system of paragraph A12, wherein the controller is configured to calculate an expected voltage at the at least one voltage tap.
A12.2. The bed heating system of paragraph A12.1, wherein the controller is configured to calculate the expected voltage based on the electrical power supplied to the heating element and a voltage tap position of the at least one voltage tap along the length of the heating element.
A12.3. The bed heating system of paragraph A12.1 or A12.2, wherein the controller is configured to detect a deviation between the detected voltage and the expected voltage at the at least one voltage tap and to regulate the electrical power supplied to the heating element based on the deviation.
A12.3.1. The bed heating system of paragraph A12.3, wherein the controller is configured to calculate the deviation between the detected voltage and the expected voltage at the at least one voltage tap and to regulate the electrical power supplied to the heating element based on the deviation.
A12.4. The bed heating system of paragraph A12.3.1, wherein the controller is configured to cease supplying the electrical power to the heating element in response to the deviation being greater than or equal to a maximum deviation percentage of the expected voltage.
A12.5. The bed heating system of paragraph A12.3 or A12.4, wherein the controller is configured to reduce the electrical power supplied to the heating element in response to the deviation being less than a/the maximum deviation percentage of the expected voltage and greater than or equal to a minimum deviation percentage of the expected voltage.
A12.6. The bed heating system of any of paragraphs A12.3-A12.5, wherein the controller is configured to reduce the electrical power, without ceasing to supply the electrical power to the heating element, in response to the deviation being less than a/the maximum deviation percentage of the expected voltage and greater than or equal to a/the minimum deviation percentage of the expected voltage.
A12.7. The bed heating system of paragraph A12.5 or A12.6, wherein the controller is configured to reduce the electrical power by at least 5%, at least 10%, at least 15%, at least 20%, at least 25%, at least 30%, at least 40%, at most 50%, at most 40%, at most 30%, at most 25%, at most 20%, and/or at most 10%, without ceasing supplying the electrical power to the heating element.
A12.8. The bed heating system of any of paragraphs A12.4-A12.7, wherein the maximum deviation percentage comprises at least 5% of the expected voltage, at least 10% of the expected voltage, at least 15% of the expected voltage, at least 20% of the expected voltage, at least 25% of the expected voltage, at least 30% of the expected voltage, at least 40% of the expected voltage, at least 45% of the expected voltage, at most 50% of the expected voltage, at most 40% of the expected voltage, at most 30% of the expected voltage, and/or at most 20% of the expected voltage.
A12.9. The bed heating system of any of paragraphs A12.5-A12.8, wherein the minimum deviation percentage is less than the maximum deviation percentage and greater than zero.
A12.10. The bed heating system of any of paragraphs A12.5-A12.9, wherein the minimum deviation percentage comprises at least 1% of the expected voltage, at least 3% of the expected voltage, at least 5% of the expected voltage, at least 8% of the expected voltage, at least 10% of the expected voltage, at least 15% of the expected voltage, at least 20% of the expected voltage, at least 25% of the expected voltage, at most 25% of the expected voltage, at most 20% of the expected voltage, at most 15% of the expected voltage, at most 10% of the expected voltage, and/or at most 5% of the expected voltage.
A12.11. The bed heating system of any of paragraphs A12.3-A12.10, wherein responsive to the deviation being less than a/the minimum deviation percentage of the expected voltage, the controller is configured to continue to supply the electrical power to the heating element and to continue to monitor the detected voltage at the at least one voltage tap.
A12.12. The bed heating system of any of paragraphs A12-A12.11, wherein the controller is configured to identify a type of the DC-heated bedding assembly based on a quantity of the at least one voltage tap and the voltage tap position of the at least one voltage tap along the length of the heating element.
A12.13. The bed heating system of paragraph A12.12, wherein the type of the DC-heated bedding assembly includes one of a DC-heated sleeping pad, a DC-heated blanket, a DC-heated sleeping bag, a DC-heated mattress cover, or a DC-heated seat cover.
A12.14. The bed heating system of any of paragraphs A12-A12.13, wherein the controller is operatively coupled to the at least one voltage tap by a multi-pin connector.
A12.15. The bed heating system of any of paragraphs A12-A12.14, wherein the at least one voltage tap comprises two or more voltage taps, each operatively coupled to the heating element at respective voltage tap positions that are spaced apart from each other along the length of the heating element.
A12.16. The bed heating system of paragraph A12.15 when depending from any of paragraphs A5.2-A5.15 or paragraphs A6.1-A6.11, wherein at least two of the two or more voltage taps are operatively coupled to a different one of the two or more zones of the heating element.
A12.17. The bed heating system of paragraph A12.16, wherein the two or more voltage taps comprise at least a first voltage tap operatively coupled to the first zone of the heating element.
A12.18. The bed heating system of paragraph A12.16 or A12.17, wherein the two or more voltage taps comprise at least a second voltage tap operatively coupled to the second zone of the heating element.
A12.19. The bed heating system of any of paragraphs A12.17-A12.18, wherein the two or more voltage taps comprise at least a third voltage tap operatively coupled to the third zone of the heating element.
A13. The bed heating system of any of paragraphs A-A12.19, wherein the DC-heated bedding assembly further comprises at least one thermistor operatively coupled to the heating element in order to detect a detected temperature of the heating element, wherein the controller is operatively coupled to the at least one thermistor and is configured to continuously monitor the detected temperature detected by the at least one thermistor.
A13.1. The bed heating system of paragraph A13, wherein the controller is configured to cease supplying the electrical power to the heating element in response to the detected temperature exceeding a maximum permitted temperature.
A13.2. The bed heating system of paragraph A13, wherein the controller is configured to determine an expected temperature to be detected by the at least one thermistor based on the electrical power supplied to the heating element, and wherein the controller is configured to reduce the electrical power supplied to the heating element, without ceasing to supply the electrical power to the heating element, in response to the detected temperature exceeding the expected temperature by at least a threshold percentage of the expected temperature.
A13.3. The bed heating system of any of paragraphs A13-A13.2, wherein the at least one thermistor comprises at least one NTC thermistor operatively coupled to the heating element in order to detect the detected temperature.
A13.4. The bed heating system of any of paragraphs A13-A13.3, wherein the controller is operatively coupled to the at least one thermistor by a/the multi-pin connector.
A13.5. The bed heating system of any of paragraphs A13-A13.4, wherein the at least one thermistor comprises two or more thermistors, each operatively coupled to the heating element at respective thermistor positions that are spaced apart from each other along the length of the heating element.
A13.6. The bed heating system of paragraph A13.5 when depending from any of paragraphs A5.2-A5.18 or paragraphs A6.1-A6.11, wherein at least two of the two or more thermistors are operatively coupled to a different one of the two or more zones of the heating element.
A13.7. The bed heating system of paragraph A13.6, wherein the two or more thermistors comprise at least a first thermistor operatively coupled to the first zone of the heating element.
A13.8. The bed heating system of paragraph A13.6 or A13.7, wherein the two or more thermistors comprise at least a second thermistor operatively coupled to the second zone of the heating element.
A13.9. The bed heating system of any of paragraphs A13.6-A13.8, wherein the two or more thermistors comprise at least a third thermistor operatively coupled to the third zone of the heating element.
A13.10. The bed heating system of any of paragraphs A13.7-A13.9, wherein the first thermistor, the second thermistor, and the third thermistor each comprise an NTC thermistor.
A14. The bed heating system of any of paragraphs A-A13.10, wherein the DC-heated bedding assembly further comprises at least one mechanical thermostat supported by the substrate, and wherein the controller is configured to monitor a measured substrate temperature detected by the at least one mechanical thermostat.
A14.1. The bed heating system of paragraph A14, wherein the controller is configured to cease supplying the electrical power to the heating element in response to the measured substrate temperature exceeding a maximum substrate temperature.
A14.2. The bed heating system of paragraph A14 or A14.1, wherein the controller is operatively coupled to the at least one mechanical thermostat by a/the multi-pin connector.
A14.3. The bed heating system of any of paragraphs A14-A14.2 when depending from any of paragraphs A5.2-A5.18, wherein the at least one mechanical thermostat is supported by a respective one of the respective end regions of the substrate.
A14.4. The bed heating system of paragraph A14.3, wherein the at least one mechanical thermostat comprises at least a first mechanical thermostat supported by the first end region of the substrate.
A14.5. The bed heating system of paragraph A14.3 or A14.4, wherein the at least one mechanical thermostat comprises at least a second mechanical thermostat supported by the second end region of the substrate.
A14.6. The bed heating system of any of paragraphs A14.3-A14.5, wherein the at least one mechanical thermostat comprises at least a third mechanical thermostat supported by the middle region of the substrate.
A15. The bed heating system of any of paragraphs A-A14.6, wherein the DC-heated bedding assembly further comprises a coupling system configured to couple the DC-heated bedding assembly to a second DC-heated bedding assembly.
A15.1. The bed heating system of paragraph A15, wherein the coupling system comprises one or more fasteners positioned along edge regions of the substrate and is configured to be coupled to a coupling system of a second DC-heated bedding assembly.
A15.2. The bed heating system of paragraph A15.1, wherein the one or more fasteners comprise one or more of snaps, zippers, side-release buckles, buttons, hook-and-loop fasteners, toggle stoppers, ties, and magnets.
A15.3. The bed heating system of any of paragraphs A15.1-A15.2, wherein the one or more fasteners are electrically coupled to the heating element and/or to the controller and configured to transmit electrical power from the heating element to a heating element of the second DC-heated bedding assembly.
A15.4. The bed heating system of any of paragraphs A15.1-A15.3, wherein the second DC-heated bedding assembly comprises a second heating element embedded in a second substrate, wherein the controller is configured to be operatively coupled to the second heating element of the second DC-heated bedding assembly via the one or more fasteners.
A15.5. The bed heating system of any of paragraphs A15-A15.4, wherein the coupling system comprises a coupling panel configured to be fastened between the DC-heated bedding assembly and the second DC-heated bedding assembly.
A15.6. The bed heating system of any of paragraphs A15-A15.5, wherein the coupling system is configured to mechanically couple the DC-heated bedding assembly and the second DC-heated bedding assembly together.
A15.7. The bed heating system of any of paragraphs A15-A15.6, wherein the coupling system is configured to electrically couple the DC-heated bedding assembly and the second DC-heated bedding assembly together.
A16. The bed heating system of any of paragraphs A15-A15.7, wherein the coupling system comprises a junction coupled to or configured to be operatively coupled to the heating element, wherein the junction is configured to be operatively coupled to the second DC-heated bedding assembly and to the DC power supply for operative powering of the DC-heated bedding assembly and the second DC-heated bedding assembly with the DC power supply.
A16.1. The bed heating system of paragraph A16, wherein the controller is configured to be operatively coupled to the junction.
A16.2. The bed heating system of paragraph A16 or A16.1, wherein the junction is configured to operatively couple together a plurality of DC-heated bedding assemblies, including the DC-heated bedding assembly and the second DC-heated bedding assembly, for operative powering with the DC power supply.
A17. The bed heating system of any of paragraphs A15-A16.2, further comprising the second DC-heated bedding assembly.
A18. The bed heating system of any of paragraphs A15-A17, wherein the controller is configured to be operatively coupled to a/the second heating element of the second DC-heated bedding assembly for operative control of the second heating element.
A19. The bed heating system of any of paragraphs A-A18, comprising a plurality of DC-heated bedding assemblies.
A19.1. The bed heating system of paragraph A19, wherein the plurality of DC-heated bedding assemblies is configured to be electrically coupled to the DC power supply in series, and wherein the DC power supply is configured to supply electrical power to each of the DC-heated bedding assemblies of the plurality of DC-heated bedding assemblies.
A19.2. The bed heating system of paragraph A19, wherein the plurality of DC-heated bedding assemblies is configured to be electrically coupled to the DC power supply in parallel, and wherein the DC power supply is configured to supply electrical power to each of the DC-heated bedding assemblies of the plurality of DC-heated bedding assemblies.
A19.3. The bed heating system of paragraph A19, wherein each DC-heated bedding assembly of the plurality of DC-heated bedding assemblies is configured to be coupled to a distinct DC power supply.
A19.4. The bed heating system of any of paragraphs A19-A19.3, wherein the controller is configured to operatively control the heating elements of the plurality of DC-heated bedding assemblies.
A19.5. The bed heating system of paragraph A19.4, wherein the controller is configured to selectively and separately regulate the electrical power supplied to each heating element of the plurality of DC-heated bedding assemblies.
A20. The bed heating system of any of paragraphs A-A19.5, wherein the DC-heated bedding assembly is configured to be rolled and/or folded, and wherein the bed heating system further comprises a wrap strap assembly configured to selectively retain the DC-heated bedding assembly in a rolled and/or folded configuration.
A20.1. The bed heating system of paragraph A20, wherein the wrap strap assembly is fixed to the DC-heated bedding assembly.
A20.2. The bed heating system of paragraph A20, wherein the wrap strap assembly is separate from the DC-heated bedding assembly.
A21. The bed heating system of any of paragraphs A-A20.2, wherein the DC-heated bedding assembly further comprises a heating surface attachment configured to selectively and operatively couple the DC-heated bedding assembly to a/the heating surface.
A21.1. The bed heating system of paragraph A21, wherein the heating surface attachment comprises one or more of a pocket sized to receive the heating surface, straps configured to extend around the heating surface, and fasteners configured to fasten to the heating surface.
A22. The bed heating system of any of paragraphs A-A21.1, further comprising a/the heating surface.
A22.1. The bed heating system of paragraph A22, wherein the DC-heated bedding assembly is operatively coupled to or is configured to be operatively coupled to the heating surface.
A22.2. The bed heating system of any of paragraphs A22-A22.1, wherein the heating surface and the substrate have at least substantially the same, the same, or a substantially similar footprint.
A23. The bed heating system of any of paragraphs A-A22.2, further comprising a DC-powered control system, comprising:
the controller configured to be operatively connected in series between the DC power supply and the heating element, wherein the controller is configured to:
   control the electrical power supplied to the heating element by the DC power supply in order to control the heat output generated by the heating element;
   monitor a/the detected voltage of a/the at least one voltage tap positioned along a/the length of the heating element;
   detect a/the deviation between the detected voltage and an/the expected voltage at the least one voltage tap; and
   regulate the electrical power supplied to the heating element based on the deviation.
A23.1. The bed heating system of paragraph A23, wherein the controller is configured to calculate the deviation between the detected voltage and the expected voltage at the at least one voltage tap.
A23.2. The bed heating system of any of paragraphs A23-A23.1, wherein the controller is further configured to cease supplying the electrical power to the heating element in response to the deviation being greater than or equal to a/the maximum deviation percentage of the expected voltage.
A23.3. The bed heating system of any of paragraphs A23-A23.2, wherein the controller is further configured to reduce the electrical power supplied to the heating element, without ceasing to supply the electrical power, in response to the deviation being less than the maximum deviation percentage and greater than or equal to a/the minimum deviation percentage of the expected voltage.
B. A DC-powered control system for a heating element, the control system comprising:
a controller configured to be operatively connected in series between a DC power supply and the heating element, wherein the controller is configured to:
   control an electrical power supplied to the heating element by the DC power supply in order to control a heat output generated by the heating element;
   monitor a detected voltage at at least one voltage tap positioned along a length of the heating element;
   detect a deviation between the detected voltage and an expected voltage at the least one voltage tap; and
   regulate the electrical power supplied to the heating element based on the deviation.
B.1. The bed heating system of paragraph B, wherein the controller is configured to calculate the deviation between the detected voltage and the expected voltage at the at least one voltage tap.
B2. The bed heating system of any of paragraphs B-B1, wherein the controller is further configured to cease supplying the electrical power to the heating element in response to the deviation being greater than or equal to a maximum deviation percentage of the expected voltage.
B3. The bed heating system of any of paragraphs B-B2, wherein the controller is further configured to reduce the electrical power supplied to the heating element without ceasing to supply the electrical power in response to the deviation being less than the maximum deviation percentage and greater than or equal to a minimum deviation percentage of the expected voltage.
B4. The DC-powered control system of any of paragraphs B-B3, wherein the controller comprises the controller of any of paragraphs A-A23.3.
B5. The DC-powered control system of any of paragraphs B-B4, wherein the DC-powered control system is configured to operate in the same manner as the controller of any of paragraphs A-A23.3.
C. A DC-heated bedding assembly comprising the features of the DC-heated bedding assembly of any of paragraphs A-A10.3, A15-A15.2, and/or A20-A22.3.
D. A bed heating system, comprising:
a DC-heated bedding assembly, comprising:
   a substrate;
   a heating element supported by the substrate, wherein the heating element is configured to be operatively coupled to a DC power supply and to generate a heat output to heat the substrate; and
   at least one voltage tap positioned along a length of the heating element; and
a controller configured to be connected in series between the DC power supply and the heating element, wherein the controller is operatively coupled to the at least one voltage tap and is configured to monitor a detected voltage at the at least one voltage tap, and wherein the controller is configured to selectively regulate an electrical power supplied to the heating element by the DC power supply based on the detected voltage in order to control the heat output generated by the heating element.
D1. The bed heating system of paragraph D, further comprising the features of the bed heating system of any of paragraphs A-A23.3.
E. A bed heating system, comprising:
a DC-heated bedding assembly, comprising:
   a substrate;
   a heating element supported by the substrate, wherein the heating element is configured to be operatively coupled to a DC power supply and to generate a heat output to heat the substrate; and
   at least one voltage tap positioned along a length of the heating element;
a DC-powered control system, comprising:
   a controller configured to be operatively connected in series between the DC power supply and the heating element, wherein the controller is configured to:
      control an electrical power supplied to the heating element by the DC power supply in order to control the heat output of the heating element;
      monitor a detected voltage at the at least one voltage tap positioned along the length of the heating element;
      detect a deviation between the detected voltage and an expected voltage at the least one voltage tap; and
      regulate the electrical power supplied to the heating element based on the deviation.
E1. The bed heating system of paragraph E, further comprising the features of the bed heating system of any of paragraphs A-A23.3.

### INDUSTRIAL APPLICABILITY

The bed heating systems disclosed herein, including DC-heated bedding assemblies and/or DC-powered control systems, are applicable to the outdoor products and camping industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A bed heating system, comprising:
a DC-heated bedding assembly, comprising:
a substrate;
a heating element supported by the substrate, wherein the heating element is configured to be operatively coupled to a DC power supply and to generate a heat output to heat the substrate; and
at least one voltage tap positioned along a length of the heating element; and
a DC-powered control system, comprising:
a controller configured to be operatively connected in series between the DC power supply and the heating element, wherein the controller is configured to:
control an electrical power supplied to the heating element by the DC power supply in order to control the heat output of the heating element;
monitor a detected voltage at the at least one voltage tap positioned along the length of the heating element;
detect a deviation between the detected voltage and an expected voltage at the least one voltage tap; and
regulate the electrical power supplied to the heating element based on the deviation.

2. The bed heating system of claim 1, wherein the substrate comprises:
a first outer layer;
a second outer layer; and
wherein the heating element is disposed between the first outer layer and the second outer layer.

3. The bed heating system of claim 1, wherein the heating element comprises a resistive heating element.

4. The bed heating system of claim 1, wherein the substrate has a longitudinal axis, wherein the heating element has two or more zones each supported by a different region of the substrate along the longitudinal axis, and wherein at least two of the two or more zones are configured to generate different heat outputs to heat the different regions.

5. The bed heating system of claim 4, wherein the two or more zones comprise at least a first zone and a second zone, wherein the first zone is supported by a first end region of the substrate and the second zone is supported by a second end region of the substrate, and wherein the first end region opposes the second end region.

6. The bed heating system of claim 5, wherein the two or more zones further comprise a third zone supported by a middle region of the substrate, wherein the middle region is disposed between the first end region and the second end region along the longitudinal axis of the substrate.

7. The bed heating system of claim 6, wherein the heat output generated by the first zone and the second zone is greater than the heat output generated by the third zone.

8. The bed heating system of claim 6, wherein the first zone has a first zone length as measured along the longitudinal axis, the second zone has a second zone length as measured along the longitudinal axis, and the third zone has a third zone length as measured along the longitudinal axis.

9. The bed heating system of claim 8, wherein the first zone length and the second zone length are at least substantially equal.

10. The bed heating system of claim 8, wherein the third zone length is greater than the first zone length and the second zone length.

11. The bed heating system of claim 4, wherein the heating element defines a sinuous path extending back and forth across and along the longitudinal axis of the substrate.

12. The bed heating system of claim 11, wherein the sinuous path has a different density in the at least two of the two or more zones that generate the different heat outputs.

13. The bed heating system of claim 1, wherein the controller is operatively coupled to the at least one voltage tap in order to monitor the detected voltage at the at least one voltage tap.

14. The bed heating system of claim 1, wherein the controller is configured to calculate the expected voltage at the at least one voltage tap based on the electrical power supplied to the heating element and a voltage tap position of the at least one voltage tap along the length of the heating element.

15. The bed heating system of claim 1, wherein the controller is configured to cease supplying the electrical power to the heating element in response to the deviation being greater than or equal to a maximum deviation percentage of the expected voltage.

16. The bed heating system of claim 1, wherein the controller is configured to reduce the electrical power, without ceasing to supply the electrical power, to the heating element in response to the deviation being less than a maximum deviation percentage of the expected voltage and greater than or equal to a minimum deviation percentage of the expected voltage.

17. The bed heating system of claim 1, wherein the at least one voltage tap comprises two or more voltage taps each operatively coupled to the heating element at respective voltage tap positions that are spaced apart from each other along the length of the heating element.

18. The bed heating system of claim 1, wherein the DC-heated bedding assembly further comprises at least one thermistor operatively coupled to the heating element in order to detect a detected temperature of the heating element, wherein the controller is operatively coupled to the at least one thermistor and is configured to monitor the detected temperature detected by the at least one thermistor.

19. The bed heating system of claim 18, wherein the controller is configured to cease supplying the electrical power to the heating element in response to the detected temperature exceeding a maximum permitted temperature.

20. The bed heating system of claim 1, wherein the DC-heated bedding assembly further comprises at least one thermostat supported by the substrate, and wherein the controller is configured to monitor a measured substrate temperature detected by the at least one thermostat.

21. The bed heating system of claim 20, wherein the controller is configured to cease supplying the electrical power to the heating element in response to the measured substrate temperature exceeding a maximum substrate temperature.

22. The bed heating system of claim 1, wherein the DC-heated bedding assembly further comprises a coupling system configured to couple the DC-heated bedding assembly to a second DC-heated bedding assembly.

23. The bed heating system of claim 22, wherein the coupling system comprises one or more fasteners positioned along one or more edge regions of the substrate, and wherein the one or more fasteners are configured to be coupled to a second coupling system of the second DC-heated bedding assembly.

24. A bed heating system, comprising:
a DC-heated bedding assembly, comprising:
a substrate;
a heating element supported by the substrate, wherein the heating element is configured to be operatively coupled to a DC power supply and to generate a heat output to heat the substrate; and
at least one voltage tap positioned along a length of the heating element; and
a controller configured to be connected in series between the DC power supply and the heating element, wherein the controller is operatively coupled to the at least one voltage tap and is configured to monitor a detected voltage at the at least one voltage tap, and wherein the controller is configured to selectively regulate an electrical power supplied to the heating element by the DC power supply based on the detected voltage in order to control the heat output generated by the heating element.

25. A DC-powered control system for a heating element, comprising:
a controller configured to be operatively connected in series between a DC power supply and the heating element, wherein the controller is configured to:
control an electrical power supplied to the heating element by the DC power supply in order to control a heat output generated by the heating element;
monitor a detected voltage at at least one voltage tap positioned along a length of the heating element;
detect a deviation between the detected voltage and an expected voltage at the least one voltage tap; and
regulate the electrical power supplied to the heating element based on the deviation.
